(19) United States
(12) Patent Application Publication
(10) Pub. No.: US 2025/0071206 A1
(43) Pub. Date: Feb. 27, 2025

(54) VISUALIZED INFORMATION GENERATION APPARATUS, VISUALIZED INFORMATION GENERATION METHOD, AND PROGRAM

(71) Applicants: NIPPON TELEGRAPH AND TELEPHONE CORPORATION, Tokyo (JP); NTT TECHNOCROSS CORPORATION, Tokyo (JP)

(72) Inventors: Izumi TAKAHASHI, Tokyo (JP); Toru OTAKA, Tokyo (JP); Joji NAKAYAMA, Tokyo (JP)

(73) Assignees: NIPPON TELEGRAPH AND TELEPHONE CORPORATION, Tokyo (JP); NTT TECHNOCROSS CORPORATION, Tokyo (JP)

(21) Appl. No.: 18/722,291

(22) PCT Filed: Dec. 22, 2021
(86) PCT No.: PCT/JP2021/047698

§ 371 Date: Jun. 20, 2024

(51) Int. Cl. H04M 3/51; G06Q 10/0639

(52) U.S. Cl. CPC H04M 3/5175; G06Q 10/06398; H04M 2203/401; H04M 2203/402

(57) ABSTRACT

A visualized information generation apparatus according to an embodiment includes a visualized information generating part configured to generate visualized information in response to an input of information indicating compliance, non-compliance, or both between an utterance content expressed by an utterance text and an utterance content expressed by a predetermined script. The visualized information is for visualizing a range estimated to be in compliance in a manner that is different from a manner in which a range estimated to be in non-compliance is visualized. The range estimated to be in compliance and the range estimated to be in non-compliance are as defined herein.

### TECHNICAL FIELD

The present invention relates to a visualized information generation apparatus, a visualized information generation method, and a program.

### BACKGROUND ART

At a contact center (also called a call center), generally, operators predetermine a talk script upon responding to customers (clients) so as to avoid differences between the operators in responding to the customers. Here, the talk script refers to an utterance content, an utterance procedure, and the like that are predetermined by the contact center. The talk script predetermines, for example, sentences, keywords, phrases, and the like that need to be uttered in items or scenes, such as the first greeting (opening), inquiry contents, customer identity verification (name, birth date, and the like), response, the last greeting (closing), and the like.

In addition, in order for the manager to confirm whether or not each operator appropriately responded to the customer, for example, the manager confirms a record of a voice call between the operator and the customer, and takes a questionnaire to the customer, thereby analyzing the results. A known technique is estimating appropriateness of the operator's response to the customer by comparing predetermined keywords with texts obtained through voice recognition of the voice call between the operator and the customer (Patent Document 1).

### RELATED ART DOCUMENTS

### Patent Documents

Patent Document 1: Japanese Laid-Open Patent Application No. 2016-143909

### SUMMARY OF THE INVENTION

### Problem to be Solved by the Invention

However, in order to confirm whether or not the operator's utterance complies with the talk script, for example, related art, such as Patent Document 1 and the like, needs to manually set a keyword to be compared in each item of the talk script, raising setting costs therefor. Also, when the talk script is expressed as a sentence (e.g., when the talk script is in a script format formed of sentences expressing the contents of an operator's utterance), it may be challenging to set a keyword for appropriately confirming whether or not this sentence was uttered.

An embodiment of the present invention has been made in view of the above, and it is an object of the present invention to estimate whether or not the operator's utterance complies with the talk script.

### Means for Solving Problem

In order to achieve the above object, a visualized information generation apparatus according to an embodiment includes: a visualized information generating part configured to generate visualized information in response to an input of information indicating compliance, non-compliance, or both between an utterance content expressed by an utterance text and an utterance content expressed by a predetermined script. The visualized information is for visualizing a range estimated to be in compliance in a manner that is different from a manner in which a range estimated to be in non-compliance is visualized. The range estimated to be in compliance is a range of the utterance content expressed by one of the utterance text or the script in which the utterance content expressed by one of the utterance text or the script is estimated to comply with the utterance content expressed by another of the utterance text or the script. The range estimated to be in non-compliance is a range of the utterance content expressed by one of the utterance text or the script in which the utterance content expressed by one of the utterance text or the script is estimated not to comply with the utterance content expressed by another of the utterance text or the script.

### Advantageous Effects of the Invention

It is possible to estimate whether or not the operator's utterance complies with the talk script.

### BRIEF DESCRIPTION OF THE DRAWINGS

FIG. 1 is a diagram illustrating one example of an overall configuration of a contact center system according to the present embodiment.

FIG. 2 is a diagram illustrating one example of a hardware configuration of an estimation apparatus according to the present embodiment.

FIG. 3 is a diagram illustrating one example of a functional configuration of the estimation apparatus according to the present embodiment.

FIG. 4 is a diagram illustrating an example of a talk script (part 1).

FIG. 5 is a diagram illustrating an example of the talk script (part 2).

FIG. 6 is a diagram illustrating an example of the talk script (part 3).

FIG. 7 is a diagram illustrating an example of the talk script (part 4).

FIG. 8 is a diagram illustrating an example of a detailed functional configuration of a compliance estimation processing part according to the present embodiment.

FIG. 9 is a diagram illustrating an example of a process flow in the case of storing a compliance history and visualizing compliance and non-compliance ranges.

FIG. 10 is a diagram describing an example of generation of correspondence information (part 1).

FIG. 11 is a diagram describing an example of generation of correspondence information (part 2).

FIG. 12 is a diagram describing an example of generation of correspondence information (part 3).

FIG. 13 is a diagram describing an example of generation of correspondence information (part 4).

FIG. 14 is a diagram illustrating an example of a compliance history.

FIG. 15 is a diagram illustrating an example of a compliance history when multiple utterances are integrated.

FIG. 16 is a diagram illustrating an example of a visualized result of compliance and non-compliance ranges (part 1).

FIG. 17 is a diagram illustrating an example of the visualized result of compliance and non-compliance ranges (part 2).

FIG. 18 is a diagram illustrating an example of a process flow in the case of visualizing a compliance state.

FIG. 19 is a diagram illustrating an example of the visualized result of the compliance state.

FIG. 20 is a diagram illustrating an example of a process flow in the case of visualizing a modification proposal, a compliance rate, an operator's utterance, and relevant information.

FIG. 21 is a diagram illustrating an example of a compliance history that integrates call rating and relevant information.

FIG. 22 is a diagram illustrating an example of the visualized result of the modification proposal (part 1).

FIG. 23 is a diagram illustrating an example of the visualized result of the modification proposal (part 2).

FIG. 24 is a diagram illustrating an example of the visualized result of the compliance rate (part 1).

FIG. 25 is a diagram illustrating an example of the visualized result of a list of operator's utterances (part 1).

FIG. 26 is a diagram illustrating an example of the visualized result of the relevant information.

FIG. 27 is a diagram illustrating an example of the visualized result of the compliance rate (part 2).

FIG. 28 is a diagram illustrating an example of the visualized result of the list of the operator's utterances (part 2).

FIG. 29 is a diagram illustrating an example of the visualized result of the list of the operator's utterances (part 3).

FIG. 30 is a diagram illustrating an example of the visualized result of the list of the operator's utterances (part 4).

### EMBODIMENTS FOR CARRYING OUT THE INVENTION

Hereinafter, an embodiment of the present invention will be described. In the present embodiment, a contact center system 1 including an estimation apparatus 10 will be described. The estimation apparatus 10 is intended for an operator at a contact center and is configured to estimate whether or not an utterance of the operator upon responding to a customer's inquiry complies with a talk script.

However, the contact center is merely illustrative, and the estimation apparatus 10 is similarly applicable to cases other than the contact center. For example, the estimation apparatus 10 is intended for a sales representative of a product, service, and the like, a contact representative of a physical store, and the like, and can estimate whether or not an utterance of the representative of interest complies with a talk script (or an equivalent conversation manual or script, or the like). More generally, the estimation apparatus 10 is intended for a person having a conversation with one or more persons, and is similarly applicable to estimation of whether or not an utterance of the person of interest complies with a talk script (or an equivalent conversation manual or script, or the like).

The following description will be given assuming that the operator at the contact center provides customers with services, such as responding to inquiries and the like, mainly by voice call. However, this is by no means a limitation. The estimation apparatus 10 is similarly applicable to cases in which the operator provides services by text chat (including chats using not only texts but also stamps, attachment files, and the like that can be sent and received), by video call, or the like.

### <Overall Configuration of the Contact Center System 1>

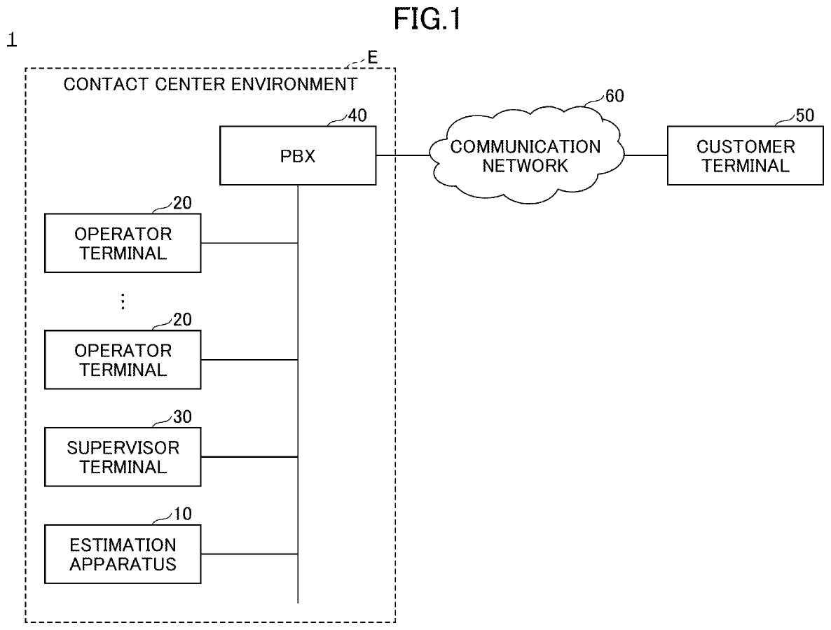

The overall configuration of the contact center system 1 according to the present embodiment is illustrated in FIG. 1. As illustrated in FIG. 1, the contact center system 1 according to the present embodiment includes an estimation apparatus 10, an operator terminal 20, a supervisor terminal 30, a PBX (private branch exchange) 40, and a customer terminal 50. The estimation apparatus 10, the operator terminal 20, the supervisor terminal 30, and the PBX 40 are installed in a contact center environment E, which is a system environment of the contact center. The contact center environment E is not limited to the system environment in the same building, and may be, for example, a system environment in multiple remote buildings.

The estimation apparatus 10 estimates whether or not the utterance of the operator upon responding to the inquiry from the customer complies with the talk script. The estimation apparatus 10 is various apparatuses, such as a general-purpose server that visualizes various information on the operator terminal 20 and the supervisor terminal 30 in accordance with the estimated results.

The operator terminal 20 is various terminals, such as a PC (personal computer) used by the operator who is responsible for responding to the inquiry from the customer, and functions as an IP (Internet Protocol) telephone apparatus. The operator terminal 20 may be a smartphone, a tablet terminal, a wearable device, or the like.

The supervisor terminal 30 is various terminals, such as a PC, used by an administrator who is responsible for managing the operators (such an administrator is also called a supervisor). The supervisor terminal 30 may be a smartphone, a tablet terminal, a wearable device, or the like.

The PBX 40 is a telephone exchange (IP-PBX) and is connected to a communication network 60 including a VOIP (Voice over Internet Protocol) network and a PSTN (Public Switched Telephone Network). The PBX40 may be a cloud-type PBX (i.e., a general-purpose server that provides a call control service as a cloud service, or the like).

The customer terminal 50 is various terminals used by the customer, such as a smartphone, a cell phone, a fixed telephone, and the like.

The overall configuration of the contact center system 1 as illustrated in FIG. 1 is merely illustrative and may be any other configuration. According to the example as illustrated in FIG. 1, the estimation apparatus 10 is included in the contact center environment E (i.e., the estimation apparatus 10 is a type of on-premises). However, for example, all or part of the functions of the estimation apparatus 10 may be implemented by a cloud service or the like. Also, the operator terminal 20 functions as an IP telephone. However, for example, a telephone may be included in the contact center system 1 separately from the operator terminal 20.

### <Hardware Configuration of the Estimation Apparatus 10>

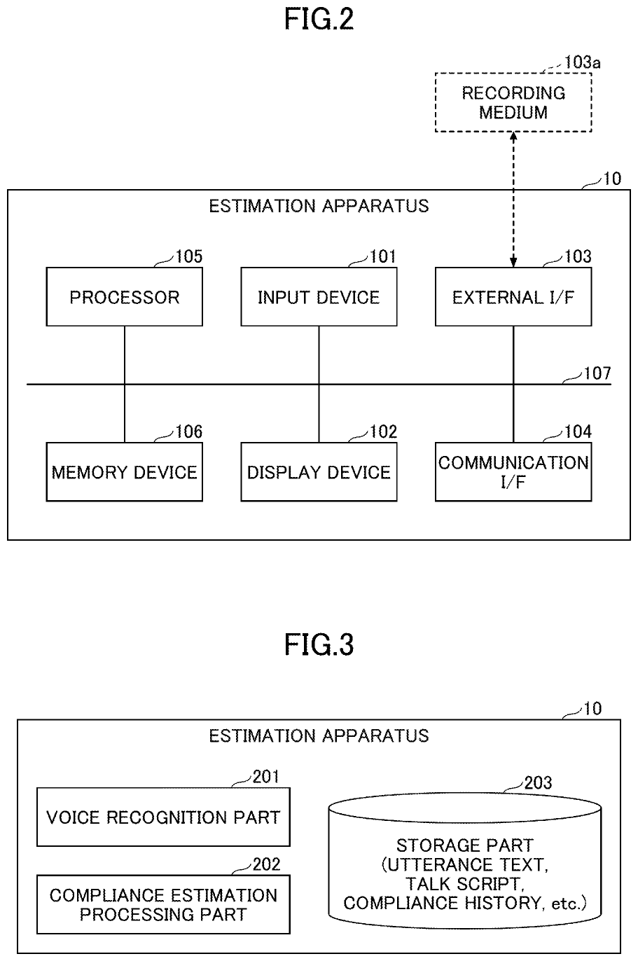

The hardware configuration of the estimation apparatus 10 according to the present embodiment is illustrated in FIG. 2. As illustrated in FIG. 2, the estimation apparatus 10 according to the present embodiment is implemented in the hardware configuration of a general computer or computer system, and includes an input device 101, a display device 102, an external I/F 103, a communication I/F 104, a processor 105, and a memory device 106. These hardware components are communicatively connected to each other via a bus 107.

The input device 101 is a keyboard, a mouse, a touch panel, or the like. The display device 102 is a display or the like. The estimation apparatus 10 may not include either or both of the input device 101 and the display device 102.

The external I/F 103 is an interface with an external device, such as a recording medium 103a. The estimation apparatus 10 can perform reading, writing, and the like of the recording medium 103a via the external I/F 103. Examples of the recording medium 103a include a CD (Compact Disc), a DVD (Digital Versatile Disk), an SD memory card (Secure Digital memory card), a USB (Universal Serial Bus) memory card, and the like.

The communication I/F 104 is an interface via which the estimation apparatus 10 communicates with other devices, equipment, and the like. The processor 105 is various calculation devices, such as a CPU (Central Processing Unit), a GPU (Graphics Processing Unit), or the like. The memory device 106 is various devices, such as an HDD (Hard Disk Drive), an SSD (Solid State Drive), a RAM (Random Access Memory), a ROM (Read Only Memory), a flash memory, and the like.

The estimation apparatus 10 according to the present embodiment has the hardware configuration as illustrated in FIG. 2, thereby implementing various processes that will be described below. The hardware configuration as illustrated in FIG. 2 is merely illustrative, and the estimation apparatus 10 may have a different hardware configuration. For example, the estimation apparatus 10 may include multiple processors 105 or may include multiple memory devices 106.

### <Functional Configuration of the Estimation Apparatus 10>

A functional configuration of the estimation apparatus 10 according to the present embodiment is illustrated in FIG. 3. As illustrated in FIG. 3, the estimation apparatus 10 according to the present embodiment includes a voice recognition part 201, a compliance estimation processing part 202, and a storage part 203. The voice recognition part 201 and the compliance estimation processing part 202 are implemented, for example, through a process of the processor 105 executed by one or more programs installed in the estimation apparatus 10. Also, the storage part 203 is implemented by the memory device 106 or the like. The storage part 203 may be implemented, for example, by a storage device or the like connected to the estimation apparatus 10 via a communication network.

The voice recognition part 201 is configured to convert a voice call between the operator and the customer to a text through voice recognition. At this time, the voice recognition part 201 may remove fillers (e.g. linking words, such as “Like”, “Uh”, “Well”, and the like) included in the voice call. Hereinafter, such a text is also referred to as an “utterance text”. Here, the utterance text may be what is obtained through textualization of the voices of both of the operator and the customer, or may be what is obtained through textualization of only the voice of the operator. The following description will be given assuming that the utterance text is what is obtained through textualization of only the voice of the operator, and through removal of the fillers.

The present embodiment assumes a voice call between the operator at the contact center and the customer, i.e., the number of speakers is two. However, this is by no means a limitation. For example, the present embodiment is similarly applicable even if the number of speakers is three or more. However, in this case, the talk script needs to be a talk script that assumes utterances between three or more speakers. Also, the relation between the speakers is not limited to a relation between an operator and a customer. Further, the speakers are not necessarily limited to humans, and at least some of the speakers may be robots, agents, and the like.

The compliance estimation processing part 202 is configured to estimate whether or not the operator's utterance complies with the talk script based on the utterance text and the talk script. The compliance estimation processing part 202 visualizes various information on the operator terminal 20 and the supervisor terminal 30 based on the estimated result obtained. Examples of the various information include information described below, such as a range of the operator's utterance in which the operator's utterance complies with the talk script (or a range of the operator's utterance in which the operator's utterance does not comply with the talk script), the state of compliance of each operator, proposals to modify the talk script or utterance, the compliance rate of each operator, the utterance of each operator, relevant information in relation to inquiries in the call from which the utterance text is obtained, and the like. Details of the functional configuration of the compliance estimation processing part 202 will be described below.

The storage part 203 is configured to store information, such as an utterance text, a talk script, a compliance history, and the like. As described below, the compliance history is, for example, history information indicating whether or not each utterance of the operator complies with the talk script.

In the example as illustrated in FIG. 3, the estimation apparatus 10 includes the voice recognition part 201. However, for example, if no voice call is performed between the operator terminal 20 and the customer terminal 50, and only the text chat is preformed, the estimation apparatus 10 may not include the voice recognition part 201.

### <Talk Script>

As described above, the talk script refers to an utterance content, an utterance procedure, and the like that are determined at a contact center. Some specific examples of the talk script will be described below. However, the talk scripts described below are merely illustrative, and the present embodiment is applicable to a given talk script. The talk script often determines sentences, utterance contents, keywords or key phrases, and the like that need to be uttered by the operator. In addition to these, for example, the talk script may determine sentences, utterance contents, keywords or key phrases, and the like that the customer is expected to utter, and may further determine operation procedures necessary for utterance (e.g., operation procedures for FAQ search, and the like).

### Specific Example 1 of Talk Script

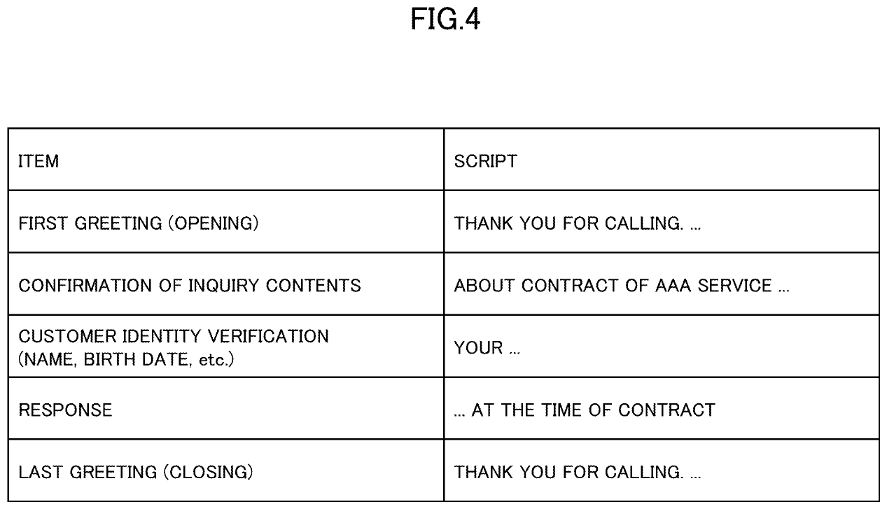

The talk script as illustrated in FIG. 4 determines, for each of the items expressing scenes or the like, a sentence that needs to be uttered by the operator in the item of interest as a script.

For example, in the item “FIRST GREETING (OPENING)”, the script “THANK YOU FOR CALLING . . . ” is determined. This means that the operator needs to utter the sentence “THANK YOU FOR CALLING . . . ” in the first greeting (opening). The same applies to the other items “CONFIRMATION OF INQUIRY CONTENTS”, “CUSTOMER IDENTITY VERIFICATION (NAME, BIRTH DATE, etc.)”, “RESPONSE”, and “LAST GREETING (CLOSING)”.

The talk script as illustrated in FIG. 4 indicates that an inquiry responding service proceeds (i.e., the talk script proceeds) in the order of “FIRST GREETING (OPENING)”, “CONFIRMATION OF INQUIRY CONTENTS”, “CUSTOMER IDENTITY VERIFICATION (NAME, BIRTH DATE, etc.)”, “RESPONSE”, and “LAST GREETING (CLOSING)”.

### Specific Example 2 of Talk Script

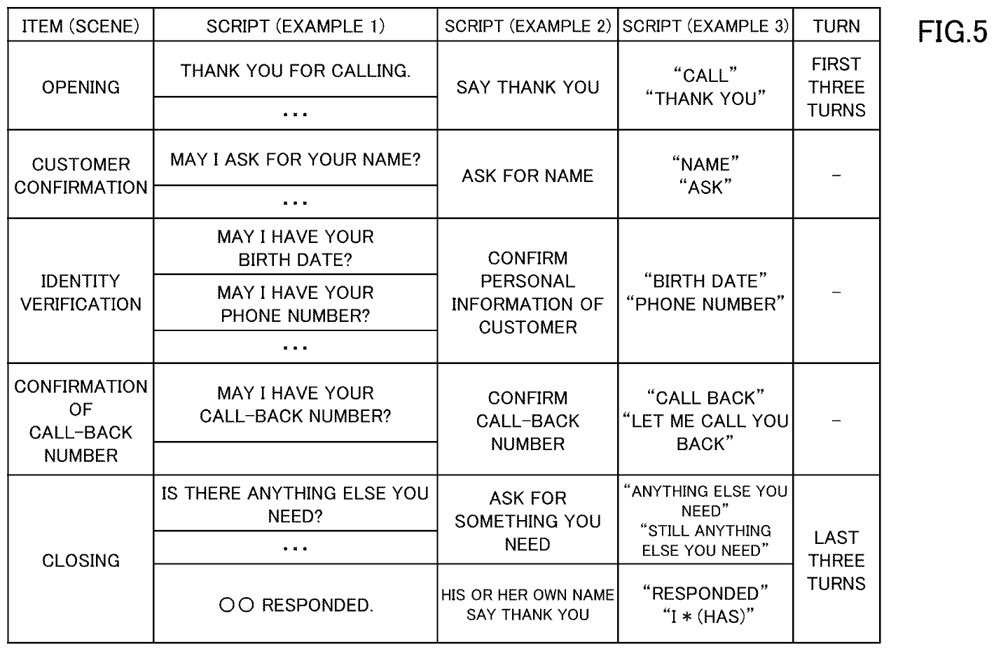

Similar to FIG. 4, the talk script as illustrated in FIG. 5 determines, for each of the items expressing scenes or the like, a sentence, an utterance content, and a keyword or key phrase that need to be uttered by the operator in the item of interest. Also, this talk script determines a turn for each item. The turn refers to an interaction of utterances between a customer and an operator. For example, “one turn” refers to a customer's utterance in response to an operator's utterance or to an operator's utterance in response to a customer's utterance.

For example, the item “OPENING” determines “THANK YOU FOR CALLING” and the like as a script (Example 1). This indicates that the operator needs to make an utterance of the sentence “THANK YOU FOR CALLING” at the opening, similar to FIG. 4.

Also, for example, the item “OPENING” determines “SAY THANK YOU” as a script (Example 2). This indicates that the operator needs to make an utterance of utterance contents that “SAY THANK YOU” at the opening (e.g., “THANK YOU”, “THANK YOU VERY MUCH”, etc.).

Also, for example, the item “OPENING” determines “CALL” and “THANK YOU” as a script (Example 3). This indicates that the operator needs to make an utterance containing the keywords (or phrases) “CALL” and “THANK YOU” at the opening.

Further, the item “OPENING” determines “FIRST THREE TURNS”. This means that three turns from the beginning of the inquiry responding service correspond to the opening.

The same applies to the other items “CUSTOMER CONFIRMATION”, “IDENTITY VERIFICATION”, “CONFIRMATION OF CALL-BACK NUMBER”, and “CLOSING”.

Of the examples as illustrated in FIG. 5, “SCRIPT (EXAMPLE 1)” is what is called “READ-OUT SCRIPT TYPE”, “SCRIPT (EXAMPLE 2)” is what is called “ACTION LISTING TYPE” (or “UTTERANCE CONTENT LISTING TYPE”), and “SCRIPT (EXAMPLE 3)” is what is called “KEYWORD TYPE”. Generally, a script is determined using one type of these, but may be determined using two or more types of these. For example, both of an utterance content and a keyword may be determined in a certain item of the talk script.

### Specific Example 3 of Talk Script

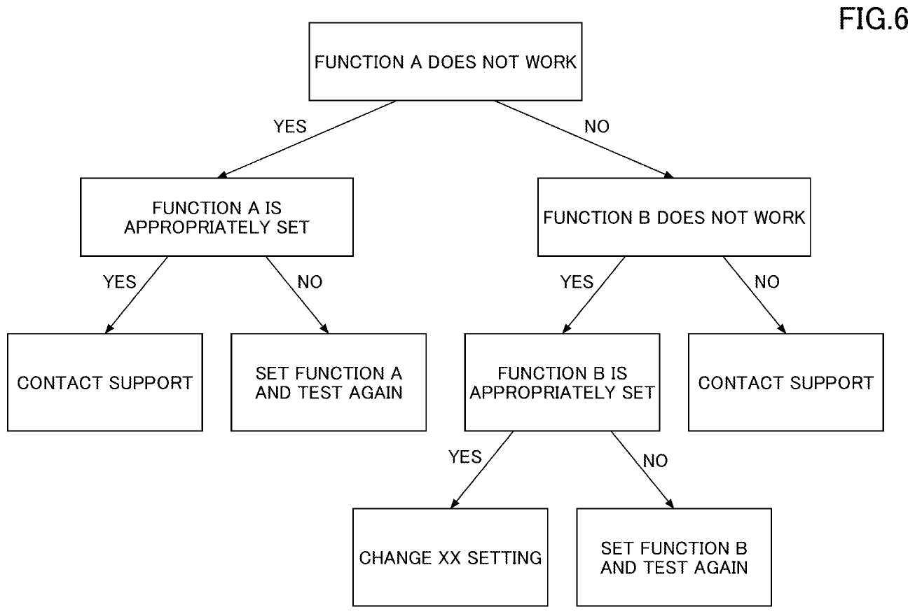

FIG. 6 is an example of a talk script used in response to inquiries about failures. Such a talk script is expressed by a tree structure in which, for example, utterance contents (scripts) that need to be uttered by the operator are nodes and transitional relations between the utterance contents are directed edges (branches).

For example, the root node of the talk script as illustrated in FIG. 6 determines the utterance content “FUNCTION A DOES NOT WORK” as a script. As expressed in this talk script, if the answer from the customer to the utterance content is YES, the talk script proceeds to the left-hand child node, and if the answer is NO, the talk script proceeds to the right-hand child node. Also, according to the talk script as illustrated in FIG. 6, the inquiry responding service proceeds (i.e. the talk script proceeds) from the root node to the leaf nodes.

According to the example as illustrated in FIG. 6, each of the nodes determines, as a script, the utterance content that needs to be uttered by the operator. However, this is by no means a limitation. For example, each node may determine, as a script, the sentence that needs to be uttered by the operator or may determine, as a script, the keyword or phrase that needs to be uttered by the operator. Also, each node may determine customer's utterance contents (or sentences, keywords, phrases, etc.). Further, the edges rather than the nodes may determine utterance contents (or sentences, keywords, phrases, etc.) as a script.

### Specific Example 4 of Talk Script

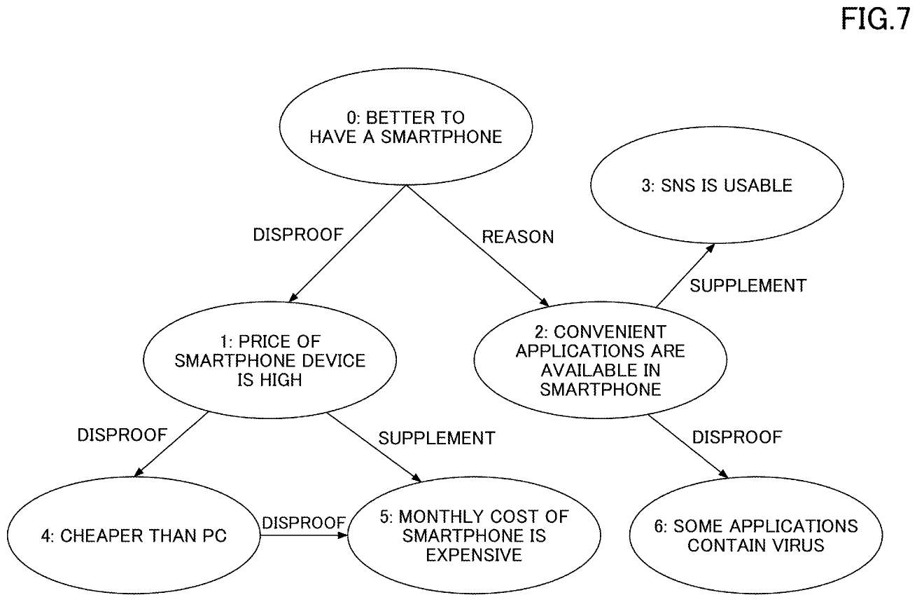

FIG. 7 is an example of a talk script used for response to inquiries in which complicated questions and answers occur (e.g., responses to inquiries about contracts of insurances, financial instruments, and the like). Such a talk script is expressed, for example, by a directed graph in which utterance contents (scripts) that need to be uttered by the operator are nodes and transitional relations between the utterance contents are directed edges.

For example, node 0 of a talk script as illustrated in FIG. 7 determines the utterance content “BETTER TO HAVE A SMARTPHONE” as a script. As expressed in this talk script, if a disproof is stated against that utterance content, the talk script proceeds to node 1, and if a reason is stated, the talk script proceeds to node 2. Also, according to the talk script as illustrated in FIG. 7, the inquiry responding service proceeds (i.e. the talk script proceeds) in the direction of the directed edge.

Similar to the talk script as illustrated in FIG. 6, each of the nodes in the example as illustrated in FIG. 7 determines, as a script, the utterance content that needs to be uttered by the operator. However, this is by no means a limitation. Each node may determine, as a script, the sentence that needs to be uttered by the operator or may determine, as a script, the keyword or phrase that needs to be uttered by the operator. Also, each node may determine customer's utterance contents (or sentences, keywords, phrases, etc.). Further, the edges rather than the nodes may determine utterance contents (or sentences, keywords, phrases, etc.) as a script.

The talk scripts of Specific Examples 1 to 4 are all merely illustrative, and the present embodiment is applicable to a given talk script. In addition to Specific Examples 1 to 4, the present embodiment is similarly applicable to, for example, the following talk scripts: a talk script that is expressed in the format that labels expressing items are attached to utterance contents; a talk script that does not determine items, scenes, or the like, and just lists the sentences that need to be uttered by the operator; and other talk scripts. Also, as described above, the present embodiment is applicable when the speaker is a robot, an agent, or the like. In this case, the talk script may be what is applied to a computer or program that implements such a robot or agent. Specific examples of the talk script applied to a computer or program include those as described in International Publication No. WO2019/172205.

### <Detailed Functional Configuration of the Compliance Estimation Processing Part 202>

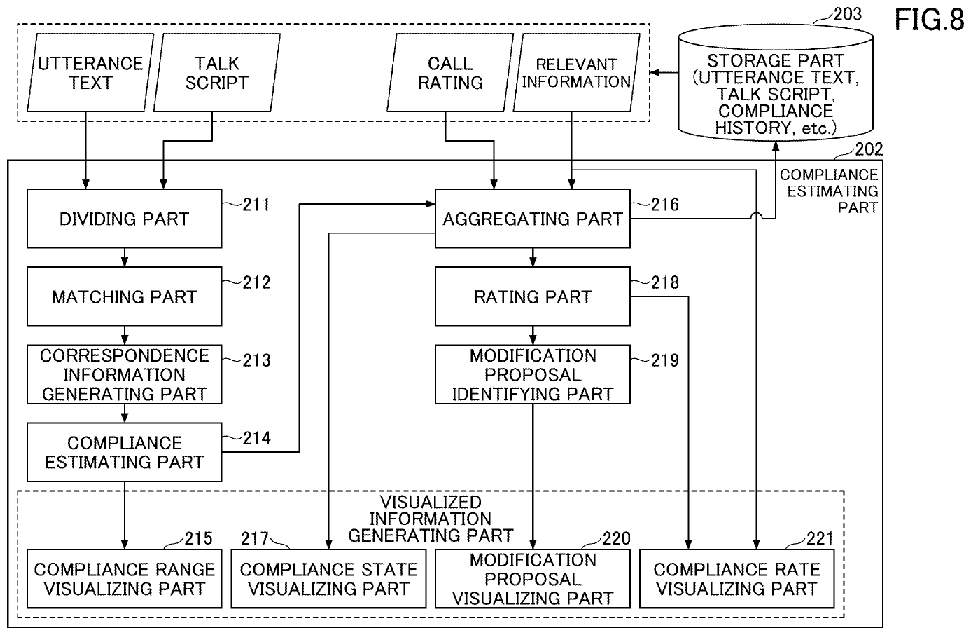

FIG. 8 is a diagram illustrating a detailed functional configuration of the compliance estimation processing part 202 according to the present embodiment. As illustrated in FIG. 8, the compliance estimation processing part 202 according to the present embodiment includes a dividing part 211, a matching part 212, a correspondence information generating part 213, a compliance estimating part 214, a compliance range visualizing part 215, an aggregating part 216, a compliance state visualizing part 217, a rating part 218, a modification proposal identifying part 219, a modification proposal visualizing part 220, and a compliance rate visualizing part 221.

The dividing part 211 is configured to divide an utterance text into certain units and divide a script included in a talk script into certain units. Hereinafter, the utterance text and the script that are divided into the certain units will also be referred to as a “divided utterance text” and a “divided script”, respectively.

The matching part 212 is configured to perform matching between the divided utterance text and the divided script in the certain units.

The correspondence information generating part 213 is configured to generate correspondence information that expresses a range of matching between the divided utterance text and the divided script.

The compliance estimating part 214 is configured to estimate whether or not the utterance text complies with the talk script (or whether or not there exists the utterance text that complies with the talk script) using the correspondence information.

The compliance range visualizing part 215 is configured to visualize a range complying with or not complying with the talk script in the utterance text (or a range of the talk script in which the utterance text complying with the script is present or absent in the talk script) on the operator terminal 20 or the supervisor terminal 30.

The aggregating part 216 is configured to aggregate estimated results obtained by the compliance estimating part 214, and generate a compliance history and store the compliance history in the storage part 203.

The compliance state visualizing part 217 is configured to visualize compliance states of utterances of multiple operators in the same talk script on the operator terminal 20 or the supervisor terminal 30.

The rating part 218 is configured to rate the operator or the talk script in accordance with call rating and relevant information. Also, the rating part 218 is configured to perform calculation of the below-described compliance rate and the like. Here, the call rating refers to information indicating results obtained by manually rating a certain call between the operator and the customer. The relevant information refers to information in relation to inquires in the call, such as search keywords of an FAQ and a responding manual in relation to the inquires (more specifically, search keywords used by the operator to search for the FAQ system and the responding manual in response to the inquires), browsing histories of the FAQ and the responding manual, additional results of a link to the text expressing an inquiry responding record (a link to the FAQ), escalation information to the supervisor, and the like. However, in addition to these, the relevant information may be, if available, information on the customer during the call (the FAQ search history in response to the past inquiry, the past inquiry information, service contract information, and the like). Also, in addition to the FAQ and the responding manual, the relevant information may be information, such as a usage history of a certain support system, if any, which can be used by the operator during responding to the customer.

The call rating is not limited to a manually determined rating, and may be obtained through automatic rating performed by a system. At this time, rating may be performed in accordance with: the number of turns, e.g., a smaller number of turns being better; automatic rating performed by a machine learning model for each sentence or scene; or validity of the operator's utterance, whether or not paraphrasing thereof is possible, or the like in accordance with the customer's reaction and the like. As the call rating, the information rated for a single call (i.e., the call ID is identical) may be used, or rating performed for each utterance (e.g., information rated by the unit of divided utterance text) may be used. Further, in the case of obtaining the call rating for a single call from the information rated for each utterance, for example, the information rated for each utterance may be scored, and an average thereof or the like may be calculated.

The modification proposal identifying part 219 is configured to identify a script to be added to the talk script, an unnecessary script, an unnecessary utterance in the utterance text, and the like as modification proposals in accordance with the rating results obtained by the rating part 218. The unnecessary script refers to, for example, a script that reduces (or can reduce) the call rating if an utterance complying with that script is made.

The modification proposal visualizing part 220 is configured to visualize the modification proposal on the operator terminal 20 or the supervisor terminal 30.

The compliance rate visualizing part 221 is configured to visualize the following on the operator terminal 20 or the supervisor terminal 30: a compliance rate at which an utterance text of an operator belonging to a certain group complies with the talk script; and a compliance rate at which an utterance text of a certain operator complies with the talk script. In addition to the compliance rate, the compliance rate visualizing part 221 visualizes the utterance text, the relevant information, and the like of each operator on the operator terminal 20 or the supervisor terminal 30.

The compliance range visualizing part 215, the compliance state visualizing part 217, the modification proposal visualizing part 220, and the compliance rate visualizing part 221 may be collectively referred to as a “visualized information generating part” or the like. In the example as illustrated in FIG. 8, an utterance text and a talk script are provided to the dividing part 211. However, in addition to these, information, such as a call ID, an operator ID, and the like, may be provided.

### <Process Flow in Storing Compliance History and Visualizing Compliance and Non-Compliance Ranges>

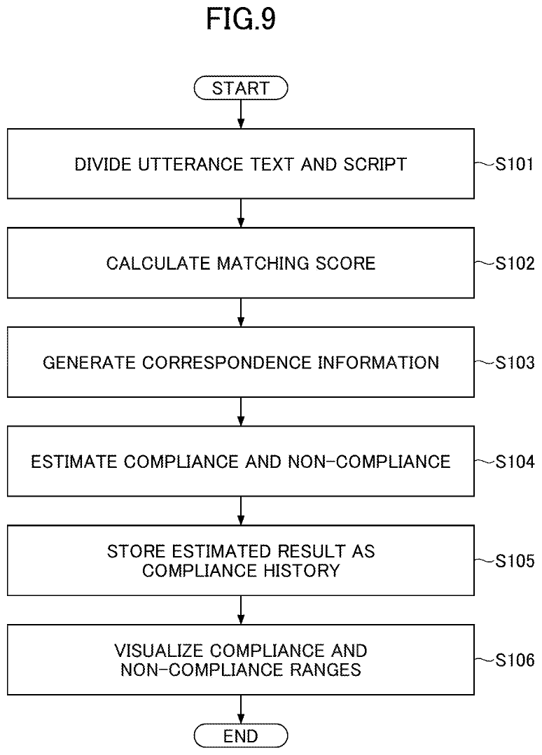

FIG. 9 illustrates a process flow in the case of storing a compliance history and visualizing compliance and non-compliance ranges. Here, the compliance range refers to a range of the utterance text in which the utterance text complies with the talk script or a range of the talk script in which the utterance text complying with the script is present in the talk script. Meanwhile, the non-compliance range refers to a range of the utterance text in which the utterance text does not comply with the talk script or a range of the talk script in which the utterance text complying with the script is absent in the talk script.

The following steps S101 to S106 (or some of these steps) may be executed in real time while a call is being made between the operator and the customer, or may be executed using the previously stored utterance texts or divided utterance texts.

Step S101: First, the dividing part 211 divides an utterance text into predetermined units and divides a script included in a talk script into predetermined units, thereby creating a divided utterance text and a divided script. The predetermined unit expresses a unit at which estimation of whether or not the utterance text complies with the talk script is intended. In the following, it is assumed that a single divided script expresses a single item or scene. At this time, because compliance or non-compliance of the operator's utterance is estimated from item to item, the item of interest may be referred to as a “compliance item” or the like. However, the single item or scene may be expressed by multiple divided scripts.

### (Dividing Method of Script)

Differing from dividing the script by the unit of the item or scene, for example, the script may be divided by a certain dividing unit or a sentence unit.

Also, the script is divided in accordance with the order in which the talk script proceeds. For example, in the case of the tree structure as illustrated in FIG. 6, the scripts existing on the paths from the root node to the leaf nodes are sequentially arranged and expanded, thereby creating divided scripts. For example, in the case of the graph structure as illustrated in FIG. 7, the scripts existing on the paths along the directed edges from a predetermined initial node to the end node are sequentially arranged and expanded, thereby creating divided scripts. However, the number of expansions may be limited by some index.

### (Dividing Method of Utterance Text)

For example, the utterance text may be divided by the unit of word or phrase, a certain dividing unit, or the like, or may be divided into utterance units or the like using an existing text dividing technique. At this time, when the utterance text is a text in a text chat, the utterance text may be divided as is. However, when the utterance text is a text obtained through conversion by voice recognition, the utterance text may be divided after processing to improve readability, such as removing fillers and the like.

The utterance text and the script do not need to be necessarily divided, and either or both of the utterance text and the script do not need to be divided. Because the utterance text can also be regarded as a divided utterance text having a divided number of 1, the “divided utterance text” in the following may include the case in which the utterance text is not divided. Similarly, because the divided script can also be regarded as a divided script having a divided number of 1, the “divided script” in the following may include the case in which the script is not divided.

Step S102: Next, the matching part 212 performs matching between the divided utterance text and the divided script by the unit of interest, and calculates a matching score indicating a matching degree therebetween.

Step S103: Next, the correspondence information generating part 213 uses the matching score calculated in step S102 and generates correspondence information expressing a range in which the divided utterance text and the divided script match each other.

In the following, an example of matching in step S102 and generation of correspondence information in step S103 will be described. However, differing from the example as described below, correspondence information may be generated, for example, by using the method described in Reference 1 (a method of obtaining sentence correspondence using a neural network) to obtain a correspondence range between the divided utterance text and the divided script.

### (Matching and Correspondence Information Generation Example (Part 1))

Description will be given of a case in which correspondence information is generated by solving matching as a combination problem.

Procedure 1-1: The matching part 212 converts each of the divided utterance texts and each of the divided scripts into features. A given method can be used as a method of conversion to features. However, for example, any one of the following Methods 1 to 3 may be used. After conversion to the feature by an apparatus different from the estimation apparatus 10, the matching part 212 may input the obtained feature.

### Method 1

Morphological analysis is performed on the divided utterance text to extract a morpheme (keyword), and a word vector expressing the extracted morpheme is used as a feature. Similarly, morphological analysis is performed on the divided script to extract a morpheme (keyword), and a word vector expressing the extracted morpheme is used as a feature.

### Method 2

Morphological analysis is performed on the divided utterance text to extract a morpheme (keyword), and a vector is obtained by converting the extracted morpheme by Word2Vec and used as a feature. Similarly, morphological analysis is performed on the divided script to extract a morpheme (keyword), and a vector is obtained by converting the extracted morpheme by Word2Vec and used as a feature.

### Method 3

A vector is obtained by converting the divided utterance text by text2vec and used as a feature. Similarly, a vector is obtained by converting the divided script by text2vec and used as a feature.

Procedure 1-2: The matching part 212 calculates a matching score between each of the divided utterance texts and each of the divided scripts using the feature calculated in procedure 1-1. Specifically, for example, when the i^{th} divided utterance text is “divided utterance text i” and the j^{th} divided script is “divided script j”, matching score sᵢⱼ between the divided utterance text i and the divided script j is calculated for i and j. As the matching score sᵢⱼ, for example, similarity (e.g., cosine similarity or the like) between the feature of the divided utterance text i and the feature of the divided script j may be calculated.

Procedure 1-3: The matching part 212 identifies a correspondence relation between the divided utterance text and the divided script using the matching score calculated in procedure 1-2. For example, the correspondence relation is identified by dynamic programming as an elastic matching problem. The present embodiment uses similarity as the matching score. Thus, when the correspondence relation is identified by dynamic programming, the value of the matching score is converted from similarity to a cost expressing a distance, followed by calculation. However, for example, the correspondence relation may be identified by integer linear programming or the like.

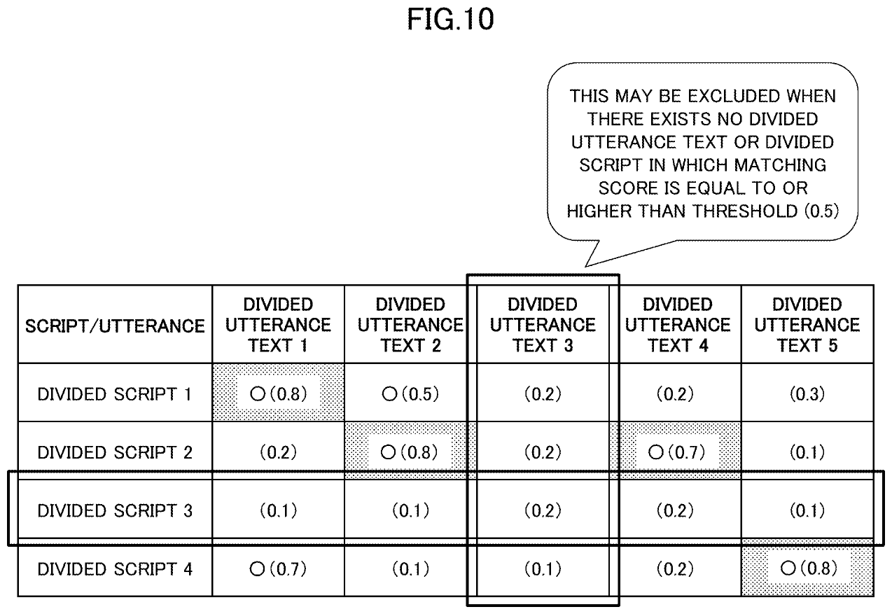

For example, it is assumed that matching scores as illustrated in FIG. 10 are calculated. In FIG. 10, the matching scores are described in parentheses in each cell. For example, the matching score between divided utterance text 1 and divided script 1 is 0.8, the matching score between divided utterance text 1 and divided script 2 is 0.2, and the matching score between divided utterance text 1 and divided script 3 is 0.1.

At this time, divided utterance text 1 and divided script 1; divided utterance text 2 and divided script 2; divided utterance text 4 and divided script 2; and divided utterance text 5 and divided script 4 are identified to correspond to each other. Therefore, in this case, divided utterance text 1 is a range complying with the item expressed by divided script 1, divided utterance text 2 and divided utterance text 4 are each a range complying with the item expressed by divided script 2, and divided utterance text 5 is a range complying with the item expressed by divided script 4.

For example, when there exists a divided utterance text whose matching score with all of the divided scripts is less than a predetermined threshold, this divided utterance text may be excluded in advance. Similarly, for example, when there exists a divided script whose matching score with all of the divided utterance texts is less than a predetermined threshold, this divided script may be excluded in advance. FIG. 10 illustrates an example in which divided utterance text 3 and divided script 3 may be excluded in advance.

For identifying the correspondence relation, the matching score may be adjusted using auxiliary information, such as turns and the like. For example, the matching score may be adjusted, for example, by adding a certain score to the matching score with a divided script belonging to a predetermined turn. As a conceivable specific example, a value of 0.2 may be added to all matching scores with divided scripts belonging to the first three turns.

When the correspondence relation is identified by solving the elastic matching problem, matching can be performed considering the divided utterance text and the order in which the divided utterance proceeds. However, when the order of the divided scripts can be disregarded, each of the divided utterance texts may be associated with one divided script having a matching score that is equal to or higher than a predetermined threshold (e.g., 0.5 or the like) or the correspondence relation may be identified by solving the maximum matching problem of a bipartite graph.

Procedure 1-4: The correspondence information generating part 213 generates correspondence relation information expressing the correspondence relation identified in procedure 1-3.

### (Matching and Correspondence Information Generation Example (Part 2))

Description will be given of a case in which correspondence information is generated by solving matching as an extraction problem.

Procedure 2-1: The matching part 212 converts each of the divided utterance texts and each of the divided scripts into features. A given method can be used as a method of conversion to features. As a conceivable method, for example, each divided utterance text and each divided script are converted to vectors of a hidden layer by a trained language model that is subjected to fine tuning with respect to a machine reading task of extracting an answer to a question text from a reading target text, and these vectors are regarded as features. In the present embodiment, description will be given of a case in which BERT (Bidirectional Encoder Representations from Transformers) is used as the trained language model. However, another trained language model may be used as long as the model can perform the same processing. The BERT is a trained natural language model used for machine reading technology and the like. See, for example, Reference 2. When the divided utterance text and the divided script are input to the BERT, these are divided into predetermined units called tokens (e.g., words, sub-words, and the like). Hereinafter, the fine-tuned trained language model as described above will be referred to as an “associating model”.

Procedure 2-2: The matching part 212 calculates a matching score between each divided utterance text and each divided script using the features calculated in procedure 2-1 in the associating model. Here, in the machine reading task of extracting an answer to a question text from the reading target text, the start point and the end point of a range to be an answer to the question text in the reading target text are output. These start and end points are determined as follows. Specifically, scores at which each token in the reading target text becomes the start point and the end point (hereinafter the scores will also be referred to as a start point score and an end point score) are calculated, and then the start point and the end point are determined from the sum of the scores (hereinafter referred to as an overall score). Regarding the divided script as the question text and the divided utterance text as the reading target text, the start point score and the end point score of each token included in the divided utterance text are calculated by the associating model (the fine-tuned BERT in the present embodiment), and these start point score and end point score are used as the matching score. For performing the fine tuning, a training data set formed of multiple sets each being a set of three pieces of information (divided script, divided utterance text, and compliance range) is used.

However, when calculating the start point score and the end point score by the associating model, the divided utterance text may be regarded as the question text and the divided script may be regarded as the reading target text.

Procedure 2-3: The matching part 212 identifies the correspondence relation between the divided utterance text and the divided script by using the matching score calculated in procedure 2-2. That is, for example, the correspondence information is created with the range in which the overall score is the highest with respect to each divided script being treated as the correspondence range of this divided script. However, when the divided utterance text is regarded as the question text and the divided script is regarded as the reading target text, the correspondence information is created with the range in which the overall score is the highest with respect to each divided utterance text being treated as the correspondence range of this divided utterance text.

Hereinafter, specific examples of procedures 2-2 and 2-3 will be described. The divided number in each of the following specific examples is merely illustrative, and the divided numbers of the utterance text, script, divided utterance token, and divided script can be determined independently of each other.

### Specific Example 1

A specific example in which the utterance text is not divided and only the script is divided in step S101 will be described.

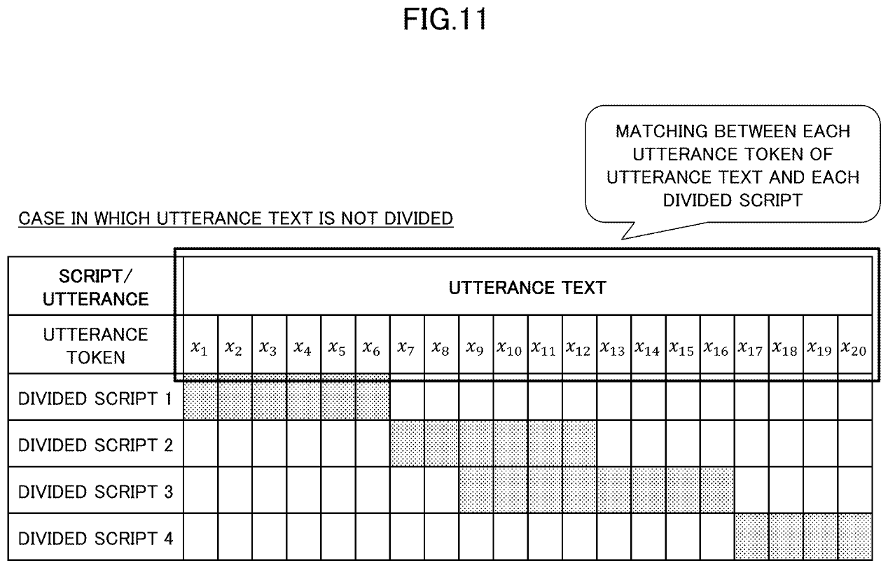

For example, as illustrated in FIG. 11, a script is divided into divided scripts 1 to 4, and when an utterance text is input to the associating model, this utterance text is divided into tokens x₁, . . . , and x₂₀. Hereinafter, these tokens x₁, . . . , and x₂₀ will also be referred to as “utterance tokens”. When the associating model is BERT, special tokens expressing the beginning of a sentence, punctuations, and the like are also input. For simplicity, description thereof will be omitted (the same applies to Specific Examples 2 and 3 as described below).

In this specific example, matching between each utterance token and each divided script is performed by the associating model, and the start point score at which each utterance token becomes a start point and the end point score at which each utterance token becomes an end point are calculated for each divided script. That is, if the kth utterance token is denoted by xx and the j^{th} divided script is denoted by “divided script j”, a start point score sₖⱼ at which the utterance token xₖ becomes a start point and an end point score eₖⱼ at which the utterance token xx becomes an end point are calculated for the divided script j.

The range in which the sum of the start point score sₖⱼ and the end point score ski becomes the maximum for the divided script j (where k≤k′) is a correspondence range of the divided script j, and correspondence information expressing this correspondence range is created. For example, in the example as illustrated in FIG. 11, the correspondence range of divided script 1 is utterance tokens x₁ to x₆, the correspondence range of divided script 2 is utterance tokens x₇ to x₁₂, the correspondence range of divided script 3 is utterance tokens x₉ to x₁₆, and the correspondence range of divided script 4 is utterance tokens x₁₇ to x₂₀.

Multiple correspondence ranges may be obtained for a certain divided script j, for example, like the correspondence range of divided script 4 is utterance tokens x₃ to x₅ and utterance tokens x₁₇ to x₂₀. In such a case, for example, the combination problem described in the “Matching and correspondence information generation example (part 1)” may be solved to specify either one of them.

Alternatively, the correspondence range in which the overall score is the highest may be selected. However, when the correspondence range in which the overall score is the highest is selected, the proceeding order of the script is likely to be disregarded. Therefore, the proceeding order may be considered by using auxiliary information, such as turns and the like. The same applies to Specific Examples 2 and 3 below.

### Specific Example 2

A specific example in which both of the utterance text and the script are divided in step S101 will be described.

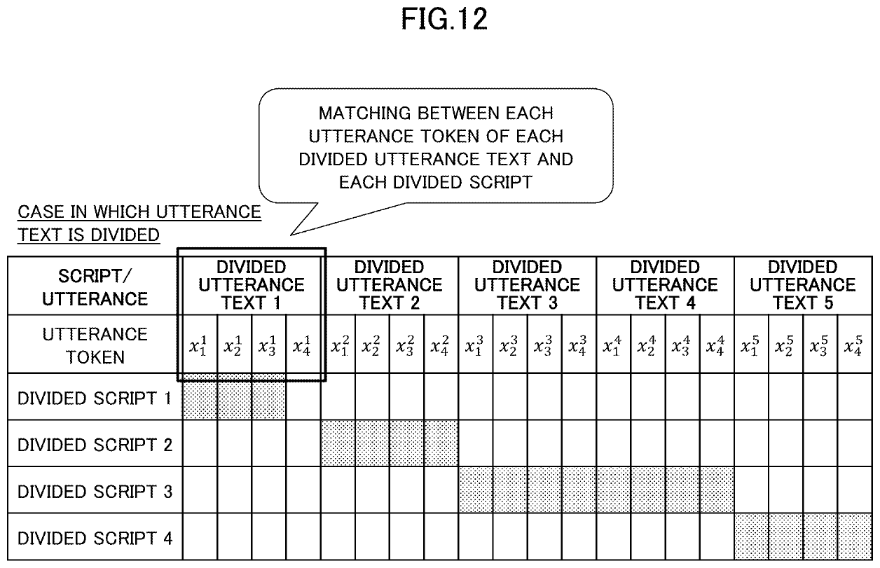

For example, as illustrated in FIG. 12, an utterance text is divided into divided utterance texts 1 to 5 and a script is divided into divided scripts 1 to 4, and when a divided utterance text i (i=1, . . . , 5) is input to the associating model, this divided utterance text i is divided into tokens x₁₁, . . . , and x₄₁. As described above, the divided numbers of them are merely illustrative, and the divided numbers of the utterance text, script, and divided utterance text can be determined independently of each other. For example, in the example as illustrated in FIG. 12, each of the divided utterance texts is divided into 4 utterance tokens, but the divided number into utterance tokens may be different for each of the divided utterance texts.

In this specific example, matching between each utterance token and each divided script is performed by the associating model for each divided utterance text, and the start point score at which each utterance token becomes a start point and the end point score at which each utterance token becomes an end point are calculated for each divided script. That is, a start point score sₖⱼⁱ at which an utterance token xₖⁱ becomes the start point and an end point score eₖⱼⁱ at which an utterance token xₖⁱ becomes the end point are calculated for the divided script j.

The range in which the sum of the start point score sₖⱼⁱ and the end point score s_{k′j}ⁱ becomes the maximum for the divided script j (where k≤k′) is a correspondence range of the divided script j, and correspondence information expressing this correspondence range is created. For example, in the example as illustrated in FIG. 12, the correspondence range of divided script 1 is utterance tokens x₁₁ to x₃₁, the correspondence range of divided script 2 is utterance tokens x₁₂ to x₄₂, the correspondence range of divided script 3 is utterance tokens x₁₃ to x₄₃ and x₁₄ to x₄₄, and the correspondence range of divided script 4 is utterance tokens x₁₅ to x₄₅.

### Specific Example 3

A specific example in which matching is performed between each utterance token included in a divided utterance text and each token included in a divided script (hereinafter also referred to as a “script token”) will be described. This specific example can be implemented, for example, by the method as described in Reference 3 (the method of obtaining word correspondence between two texts). Therefore, in this specific example, the model as described in Reference 3 is used as the associating model.

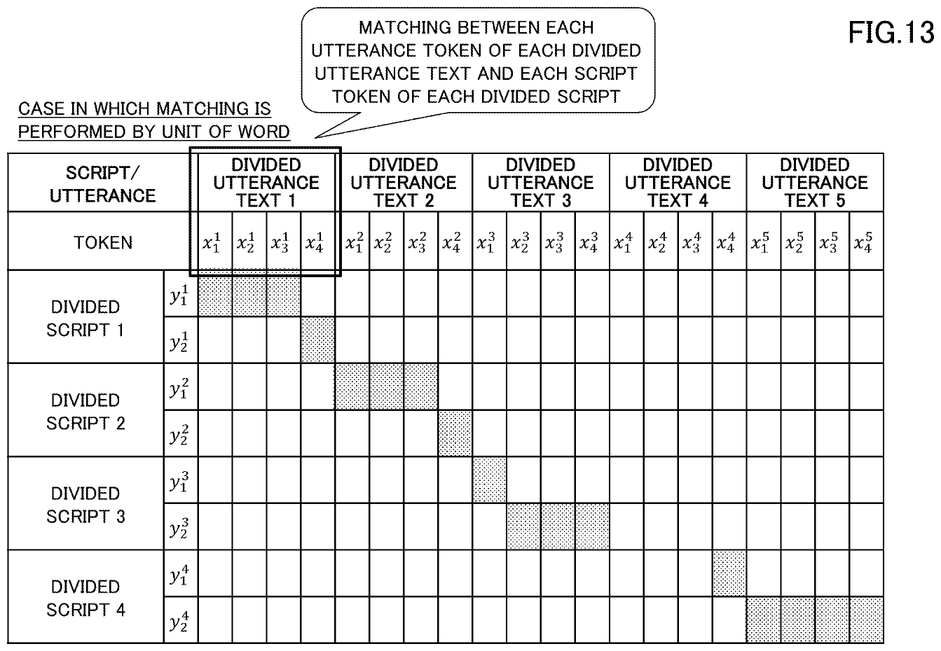

For example, as illustrated in FIG. 13, an utterance text is divided into divided utterance texts 1 to 5 and a script is divided into divided scripts 1 to 4. Also, when a divided utterance text i (i=1, . . . , 5) is input to the associating model, this divided utterance text is divided into tokens x₁ⁱ, . . . , and x₄ⁱ, and when a divided utterance text j (i=1, . . . , 4) is input to the associating model, this divided utterance text is divided into tokens y₁^{j} and y₂^{j}. As described above, the divided numbers of them are merely illustrative, and the divided numbers of the utterance text, script, divided utterance text, and divided script can be determined independently of each other. For example, in the example as illustrated in FIG. 13, the divided utterance texts are each divided into 4 utterance tokens and the divided scripts are each divided into 2 script tokens. However, the divided number into utterance tokens may be different for each divided utterance text, and similarly, the divided number into script tokens may be different for each divided script.

In this specific example, for each divided utterance text, matching between each utterance token and each script token of each divided script is performed by the associating model for each divided utterance text, and the start point score at which each utterance token becomes a start point and the end point score at which each utterance token becomes an end point are calculated for each script token of each divided script. That is, a start point score sₖₘⱼⁱ at which an utterance token xₖⁱ becomes the start point and an end point score eₖₙⱼⁱ at which an utterance token xₖⁱ becomes the end point are calculated for a script token yₘ^{j} of the divided script j.

The range in which the sum of the start point score sₖₘⱼⁱ and the end point score s_{k′mj}ⁱ becomes the maximum for the script token yₙ^{j} of the divided script j (where k≤k′) is a correspondence range of the script token yₘ^{j}, and correspondence information expressing this correspondence range is created. For example, in the example as illustrated in FIG. 13, the correspondence range of script token y₁¹ of divided script 1 is utterance tokens x₁¹ to x₃¹, the correspondence range of script token y₂¹ of divided script 1 is utterance token x₄₁, the correspondence range of script token y₁² of divided script 2 is utterance tokens x₁₂ to x₃₂, the correspondence range of script token y₂² of divided script 2 is utterance token x₄₂, and the like. In the example as illustrated in FIG. 13, there exists no script token for utterance tokens x₁₄ to x₃⁴.

Step S104: Next, by using the correspondence information generated in step S103, the compliance estimating part 214 estimates: whether or not the utterance text complies with the talk script; or whether or not there exists the utterance text complying with the talk script, in accordance with a predetermined estimation condition. Hereinafter, the fact that the utterance text complies with the talk script will be referred to as “utterance compliance”, and the fact that the utterance text does not comply with the talk script will be referred to as “utterance non-compliance”. Meanwhile, the fact that there exists the utterance text complying with the talk script will be referred to as “script compliance”, and the fact that there does not exist such an utterance text will be referred to as “script non-compliance”.

Examples of the predetermined estimation condition as described above include, for example, a condition of whether or not a determination target text corresponding to a determination base text exists as the correspondence information, with the “determination base text” being a text based on which determination is to be performed and the “determination target text” being a text for which determination is to be performed. Under this estimation condition, when there exists a divided script (determination target text) corresponding to a certain divided utterance text (determination base text), this divided utterance text is estimated to be in utterance compliance. Meanwhile, when there does not exist the corresponding divided script, this divided utterance text is estimated to be in utterance non-compliance.

Also, when there exists a divided utterance text (determination target text) corresponding to a certain divided script (determination base text), this divided script is estimated to be in script compliance. Meanwhile, when there does not exist the corresponding divided utterance text, this divided script is estimated to be in script non-compliance.

However, even if a determination target text corresponding to a determination base text exists as the correspondence information, when a matching score is equal to or lower than a certain predetermined threshold, estimation as utterance non-compliance or script non-compliance may be made. This is a case of using, as an estimation condition, the condition “whether or not a determination target text corresponding to a determination base text exists as the correspondence information” that is further limited with a matching score.

The compliance estimating part 214 may estimate whether or not a call (i.e., all utterances in one response) complies with the talk script. For example, the compliance estimating part 214 may estimate that the call complies with the talk script when a percentage of the divided utterance texts estimated to be in “compliance” of the divided utterance texts in a single call satisfies a certain condition (e.g., 80% or more, or the like). Alternatively, for example, the compliance estimating part 214 may estimate that the call complies with the talk script when utterances comply with the items that must be complied with in each of the items in the talk script, or may estimate whether or not the call complies with the talk script by various rule-based methods other than this.

Step S105: Next, the aggregating part 216 creates a compliance history from the estimated results obtained in step S104 (utterance compliance or utterance non-compliance of divided utterance texts, and script compliance or script non-compliance of each divided script) and the like, and stores the compliance history in the storage part 203.

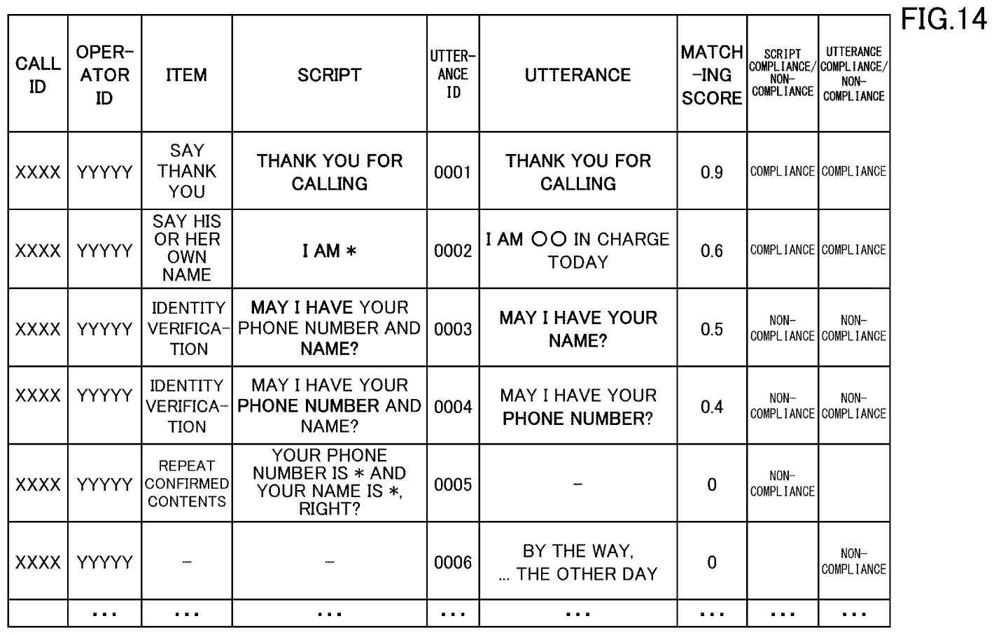

An example of the compliance history is illustrated in FIG. 14. In the compliance history as illustrated in FIG. 14, a call ID, an operator ID, an item, a script, an utterance ID, an utterance, a matching score, script compliance/non-compliance, and utterance compliance/non-compliance are associated with each other. In addition to these, for example, a script ID, a script item ID, and the like may be further associated.

Here, the call ID is an ID that identifies a call between an operator and a customer, the operator ID is an ID that identifies an operator, and the item is a compliance item of a talk script. The script is a script belonging to the compliance item. In the example as illustrated in FIG. 14, the script is a single divided script. The utterance ID is an ID that identifies a certain utterance unit by the operator, and the utterance is an utterance text in this utterance unit. In the example as illustrated in FIG. 14, the utterance is a single divided utterance text. The matching score is a matching score between the divided script and the divided utterance text. In the example as illustrated in FIG. 14, the matching score is a value obtained as follows. Specifically, matching scores are calculated by the method described in the specific example as illustrated in FIG. 13, and the calculated matching scores are averaged in terms of the divided utterance text (or the divided script). The script compliance/non-compliance and the utterance compliance/non-compliance are the estimated results obtained in step S104.

In the example as illustrated in FIG. 14, the range in which the script and the utterance correspond to each other is expressed in bold characters (bold). For example, in the script “MAY I HAVE YOUR PHONE NUMBER AND NAME?” at line 3 in the example as illustrated in FIG. 14, the part “May I have your name?” is expressed in bold, meaning that the corresponding utterance exists. Similarly, the utterance “MAY I HAVE YOUR NAME?” is expressed in bold, meaning that the corresponding script exists. Meanwhile, the script at line 4 in the example as illustrated in FIG. 14, “MAY I HAVE YOUR PHONE NUMBER AND NAME?”, means that the utterance corresponding to “MAY I HAVE YOUR NAME?” does not exist. In accordance with the correspondence information, it is determined whether or not there exists a range in which the script and the utterance correspond to each other.

According to the compliance history at lines 3 and 4 in the example as illustrated in FIG. 14, there exist an utterance corresponding to the script and a script corresponding to the utterance. However, the matching score is equal to or lower than a certain threshold (e.g., 0.5), and thus, the estimated result of non-compliance is provided as the script compliance/non-compliance and the utterance compliance/non-compliance.

Here, when multiple utterances are associated with the same compliance item, the aggregating part 216 may integrate these utterances. At this time, by adding the matching score of the integrated utterance, the values set for the script compliance/non-compliance and the utterance compliance/non-compliance may be changed.

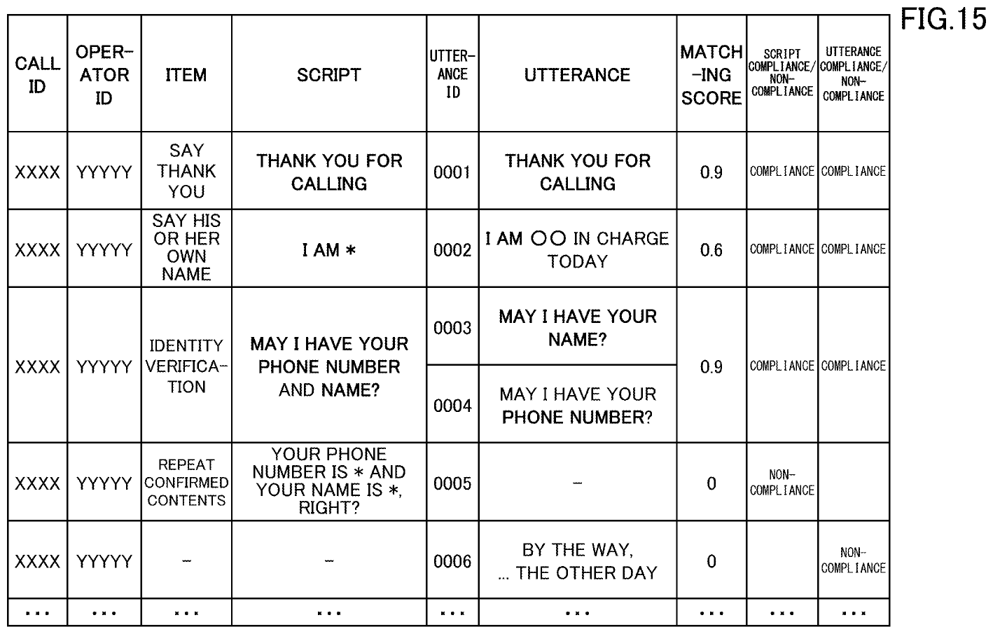

For example, FIG. 15 illustrates a compliance history that integrates the compliance histories at lines 3 and 4 in the compliance history as illustrated in FIG. 14. In the example as illustrated in FIG. 15, as a result of integrating lines 3 and 4 of the compliance history as illustrated in FIG. 14, the matching score at line 3 of the compliance history as illustrated in FIG. 15 becomes 0.9, resulting in changing both of the script compliance/non-compliance and the utterance compliance/non-compliance to “COMPLIANCE”.

As described above, when multiple divided utterances are associated with a single divided script, by pointing a cursor or the like to any one of the divided utterances, the range of the corresponding divided script may be further highlighted (e.g., highlighted in red, or the like).

Step S106: The compliance range visualizing part 215 generates information for visualizing the following ranges (e.g., screen information for display on a user interface; hereinafter also referred to as visualized information): a range of the utterance text in which the utterance text complies with the talk script and a range of the utterance text in which the utterance text does not comply with the talk script (hereinafter also referred to as an “utterance compliance range” and an “utterance non-compliance range”, respectively) or a range of the talk script in which the utterance text complying with the script is present in the talk script and a range of the talk script in which the utterance text complying with the script is absent in the talk script (hereinafter also referred to as a “script compliance range” and a “script non-compliance range”, respectively). The compliance range visualizing part 215 transmits the generated visualized information to the operator terminal 20 or the supervisor terminal 30. Thereby, the utterance compliance range and the utterance non-compliance range, the script compliance range and the script non-compliance range, and the like are visualized, for example, on the display of the operator terminal 20 or the supervisor terminal 30. This step does not need to be necessarily executed after step S105, but may be executed after step S103. However, when this step is executed after step S103, only the correspondence information is visualized (e.g., as in the example as illustrated in FIG. 15, a script or an utterance in which the range having the correspondence information is displayed in bold is visualized).

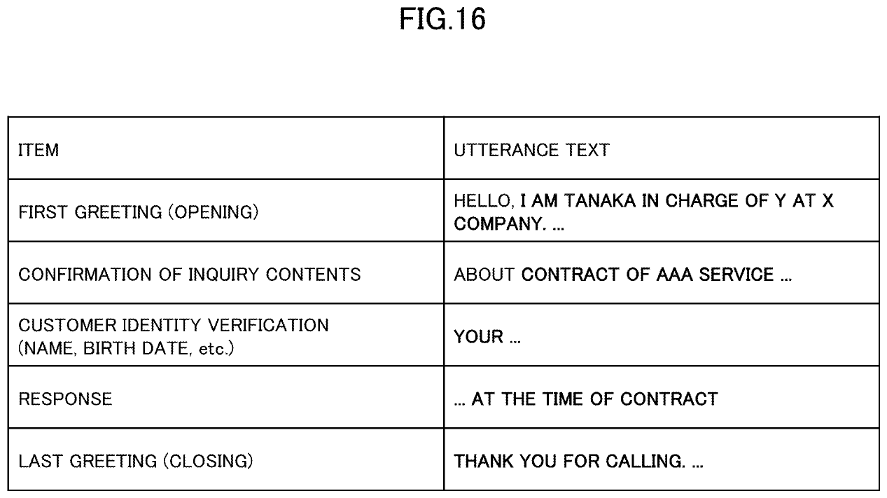

FIG. 16 illustrates an example of the visualized result of the utterance compliance range and the utterance non-compliance range. In the example as illustrated in FIG. 16, for each item, a range of an utterance text complying with the item (utterance compliance range) is expressed in bold characters (bold). Meanwhile, the range not expressed in bold characters indicates the utterance non-compliance range. Thereby, the operator or the supervisor can confirm which range of the utterance text complies with which item in the talk script.

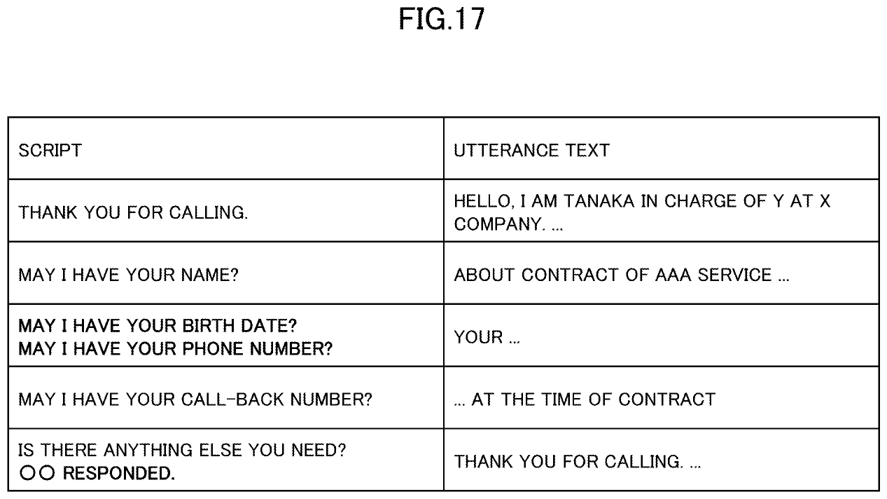

FIG. 17 illustrates an example of the visualized result of the script compliance range and the script non-compliance range. In the example as illustrated in FIG. 17, for each script belonging to the item, a range of a script including a compliant utterance text (script compliance range) is expressed in bold characters (bold). Meanwhile, the range not expressed in bold characters indicates the script non-compliance range. Thereby, the operator or the supervisor can confirm which of the scripts belonging to each item includes an utterance text that complies with that script.

Here, the visualized information of the utterance compliance range and the utterance non-compliance range and the visualized information of the script compliance range and the script non-compliance range are created from the estimated results obtained in step S104 (or the compliance history that is a history of the estimated results). However, these may be created from the correspondence information. For example, when step S106 is executed after step S103, the visualized information is created from the correspondence information. Also, the visualized information of the utterance compliance range and the utterance non-compliance range and the visualized information of the script compliance range and the script non-compliance range may be respectively created from both of the correspondence information and the estimated results obtained in step S104 (or the compliance history that is a history of the estimated results). In this case, which visualized information to use for visualization may be determined, for example, in accordance with user's selection, setting, or the like.

In the examples as illustrated in FIG. 16 and FIG. 17, the utterance compliance range and the script compliance range are expressed in bold characters, which are merely illustrative. The manner of highlighting is not limited to use of bold characters as long as the compliance ranges can be distinguished from the non-compliance ranges. For example, the utterance compliance range and the script compliance range may be changed in color, highlighted, or the like.

Either the utterance compliance and non-compliance ranges or the script compliance and non-compliance ranges may be visualized on the operator terminal 20 or the supervisor terminal 30. Both the utterance compliance and non-compliance ranges and the script compliance and non-compliance ranges may be visualized on the operator terminal 20 or the supervisor terminal 30. Also, not only the utterance compliance range and the script compliance range but also the compliance rate, the number of compliant cases, the matching score, and the like may be visualized. At this time, when the compliance rate, the number of compliant cases, the matching score, and the like are visualized together with the utterance compliance range and the script compliance range, visual effects may be changed, for example, by changing the size of the bold characters, the color, and the like in the utterance compliance range and the script compliance range in accordance with the values of the compliance rate, the number of compliant cases, the matching score, and the like. When calculating the compliance rate and the number of compliant cases, for example, the compliance or non-compliance may be calculated by the unit of item of the talk script, or the compliance or non-compliance may be calculated by the unit of divided scripts.

### <Process Flow in the Case of Visualizing Compliance State>

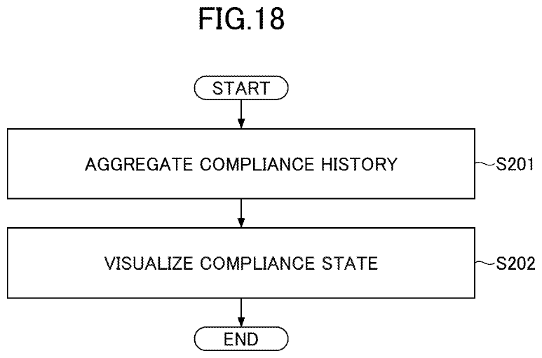

FIG. 18 illustrates a process flow in the case of visualizing a compliance state. Here, the compliance state refers to a total number of compliant cases of each script in the talk script.

Step S201: First, the aggregating part 216 aggregates the compliance histories stored in the storage part 203. For example, the aggregating part 216 aggregates, for each script, the number of script compliances (i.e., the total number of “COMPLIANCE” provided in the script compliance/non-compliance). This aggregated result is the compliance state of utterances of multiple operators in the same talk script. Upon aggregation, for example, only the number of the script compliances of utterances of operators belonging to a specific group (e.g., a specific department, a group responsible for a specific inquiry, a specific incoming number, and the like) may be aggregated. Also, for example, the compliance histories obtained when the same operator responds multiple times using the same talk script may be aggregated (thereby, in the visualized result of the compliance state as described below, the operator can confirm a more compliant part and a less compliant part in the talk script). Further, for example, the compliance histories may be aggregated by day so that the operator can confirm the visualized result of the compliance state as described below by day (especially in the order of date) (thereby, it is possible to verify, for example, “whether or not accumulation of experiences enables being compliant”).

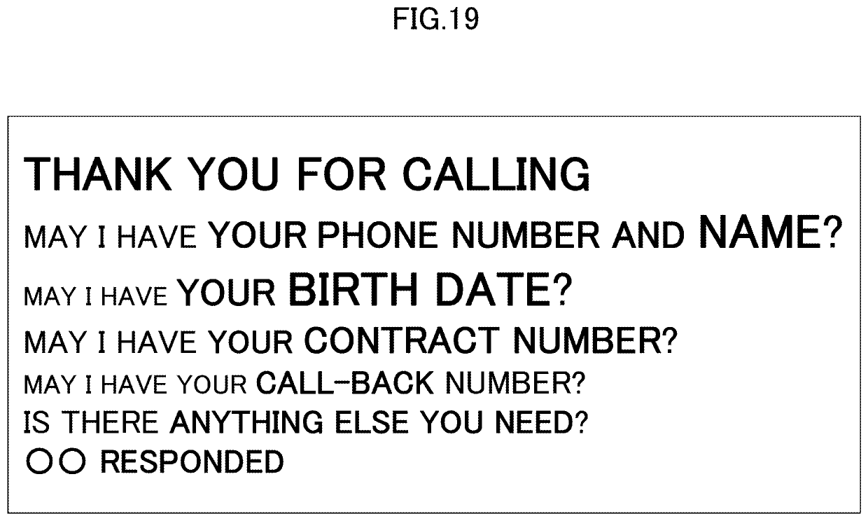

Step S202: The compliance state visualizing part 217 generates the visualized information of the compliance state of utterances of multiple operators in the same talk script, and transmits the generated visualized information to the operator terminal 20 or the supervisor terminal 30. Thereby, the compliance state is visualized on the display or the like of the operator terminal 20 or the supervisor terminal 30. An example of the visualized result of the compliance state is illustrated in FIG. 19. In the example as illustrated in FIG. 19, scripts, such as “THANK YOU FOR CALLING”, “MAY I HAVE YOUR PHONE NUMBER AND NAME?”, “MAY I HAVE YOUR BIRTH DATE?”, “MAY I HAVE YOUR CONTRACT NUMBER?”, and the like are visualized, and the scripts having a larger number of compliances are visualized in larger characters (i.e., highlighted). Visualizing the scripts having a larger number of compliances in larger characters is merely illustrative, and scripts may be visualized in any manner as long as scripts having a larger number of compliances are highlighted to a higher extent. Thereby, the operator or the supervisor can know which scripts are likely (or unlikely) to comply with.

### <Process Flow for Visualization of Modification Proposal, Compliance Rate, Operator's Utterance, and Relevant Information>

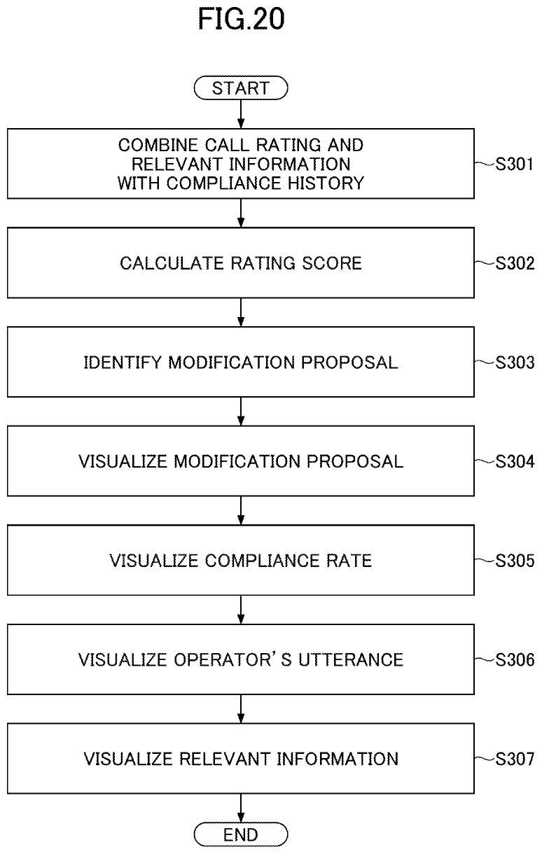

FIG. 20 illustrates a process flow in the case of visualizing a modification proposal, a compliance rate, an operator's utterance, and relevant information. Here, the modification proposal refers to: an utterance text that is currently non-compliant with the script but is regarded that inclusion thereof in the script is better (script addition proposal); a script that is regarded that deletion thereof from the talk script is better (script deletion proposal); and an utterance text that is unnecessary and non-compliant with the script (utterance modification proposal).

For example, relevant information having high relevancy with an utterance text that has become the script addition proposal (e.g., frequently-used search keywords in FAQ when this utterance text is uttered, links to FAQ, and the like) may be used as the modification proposal together with the script addition proposal.

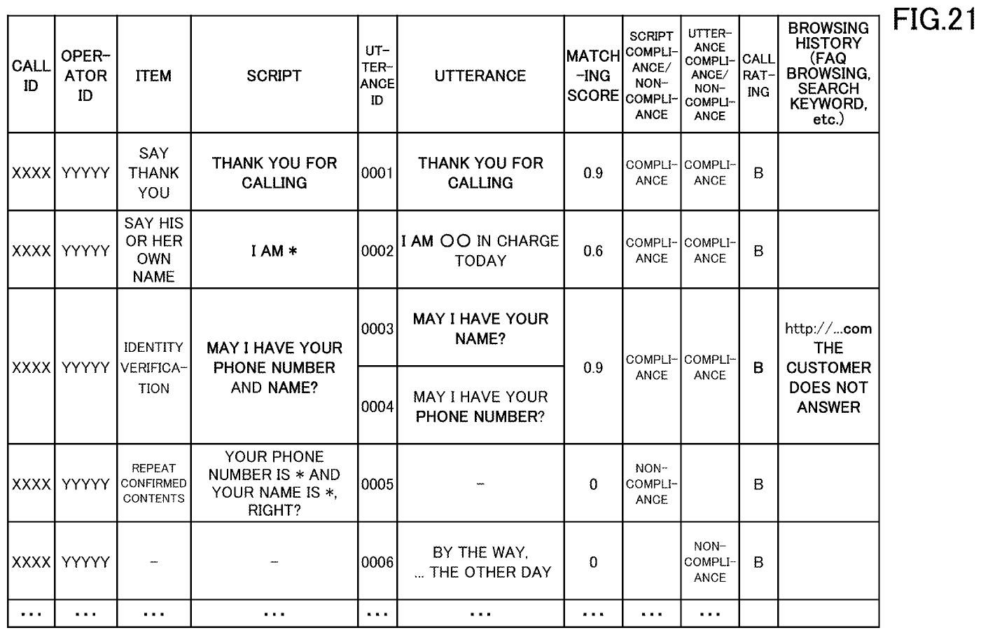

Step S301: First, the aggregating part 216 combines the call rating and the relevant information with the compliance histories stored in the storage part 203. FIG. 21 illustrates a result obtained by combining the call rating and the relevant information with the compliance histories as illustrated in FIG. 15. In the example as illustrated in FIG. 21, the call rating is in accordance with stepwise rating of “A”, “B”, “C”, or the like. This is by no means a limitation. The call rating may be in accordance with a numerical value, such as a score or the like.

Step S302: Next, the rating part 218 calculates a rating score in a certain unit (e.g., the unit of an operator, the unit of a talk script, or the like) using the compliance histories stored in the storage part 203. Examples of the rating score include a compliance rate, a precision rate, a recall rate, an F-measure, and the like. The compliance rate, the precision rate, and the recall rate are not necessarily proportions or percentages, and may be called, for example, a compliance degree, a precision degree, a recall degree, and the like.

The compliance rate by the unit of operator may be, for example, a proportion (percentage) of the divided utterance text estimated to be in the utterance compliance among the divided utterance texts of the operator. The compliance rate by the unit of operator may be “(Number of divided utterance texts of the operator that comply with the talk script)/(Total number of divided utterance texts of the operator)”. The recall rate by the unit of operator may be “(Number of items complied with by utterance texts of the operator among the compliance items of the talk script)/(Number of the total compliance items of the talk script)”. The F-measure by the unit of operator may be a harmonic mean of the precision rate by the unit of operator and the recall rate by the unit of operator.

The compliance rate by the unit of talk script may be a proportion (percentage) of the divided scripts estimated to be in the script compliance among the divided scripts of the talk script. The precision rate by the unit of talk script may be “(Number of divided utterance texts complying with the talk script among the divided utterance texts when the talk script is used)/(Total number of divided utterance texts when the talk script is used)”. The recall rate by the unit of talk script may be “(Number of items complied with by utterance texts among the compliance items of the talk script when the talk script is used)/(Number of the total compliance items of the talk script)”. The F-measure by the unit of talk script may be a harmonic mean of the precision rate by the unit of talk script and the recall rate by the unit of talk script.

In addition to the above, for example, the rating score may be calculated by the unit of operator belonging to a specific group (e.g., a specific department, a group responsible for a specific inquiry, a specific incoming number, and the like). Also, the rating score may be calculated by the unit of item of the talk script. Further, the rating score may be calculated by the unit of operator and by the unit of item of the talk script.

For example, the compliance rate by the unit of operator and by the unit of item of the talk script may be a proportion (percentage) of the divided utterance texts estimated to be in utterance compliance regarding the item of interest among the operator's divided utterance texts of the item of interest. Other rating scores may be similarly calculated using the utterance text filtered by the item as appropriate.

Step S303: Next, the modification proposal identifying part 219 identifies either or both of the script modification and the utterance modification proposal using the rating score calculated in step S302.

Here, as the script addition proposal, for example, it is conceivable to identify an operator's utterance text having a high call rating but a low compliance rate. Further, as the script deletion proposal, for example, it is conceivable to identify an operator's utterance text having a low call rating but a high compliance rate, or to identify a script of a compliance item having a low call rating and a low compliance rate. Further, as the utterance modification proposal, for example, it is conceivable to identify an utterance text having a low call rating and a low compliance rate. These are merely illustrative, and the script addition proposal, the script deletion proposal, and the utterance modification proposal may be identified using the precision rate, the recall rate, the F-measure, and the like.

Step S304: Next, the modification proposal visualizing part 220 generates visualized information of the modification proposals identified in step S303 (the script addition proposal, the script deletion proposal, and the utterance modification proposal) and transmits the generated visualized information to the operator terminal 20 or the supervisor terminal 30. Thereby, the modification proposals (the script addition proposal, the script deletion proposal, and the utterance modification proposal) are visualized on the display of the operator terminal 20 or the supervisor terminal 30. For example, preferably, the script addition proposal and the script deletion proposal are visualized on the supervisor terminal 30, and the utterance modification proposal is visualized on the operator terminal 20.

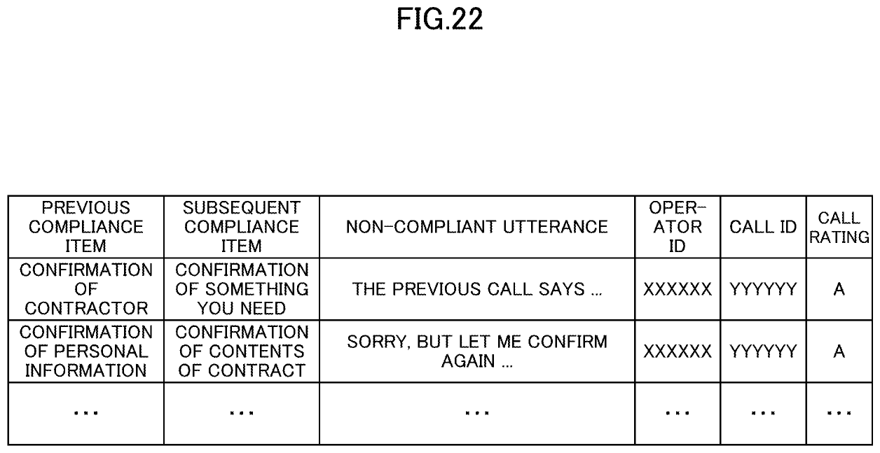

FIG. 22 illustrates an example of the visualized result of the script addition proposal. In the example as illustrated in FIG. 22, the utterance text of the operator is visualized in “NON-COMPLIANT UTTERANCE”. This utterance text is an utterance that has a high call rating (“A” in the example as illustrated in FIG. 22) but does not comply with the talk script. Therefore, the supervisor can consider what script should be added to the talk script in consideration of this utterance text.

In the example as illustrated in FIG. 22, items with which the utterances before and after the utterance text of interest comply (the previous compliance item and the subsequent compliance item) are also visualized. Thereby, the supervisor can confirm before and after what scene the non-compliant utterance was uttered. Further, utterance texts before and after the utterance text of interest may be visualized.

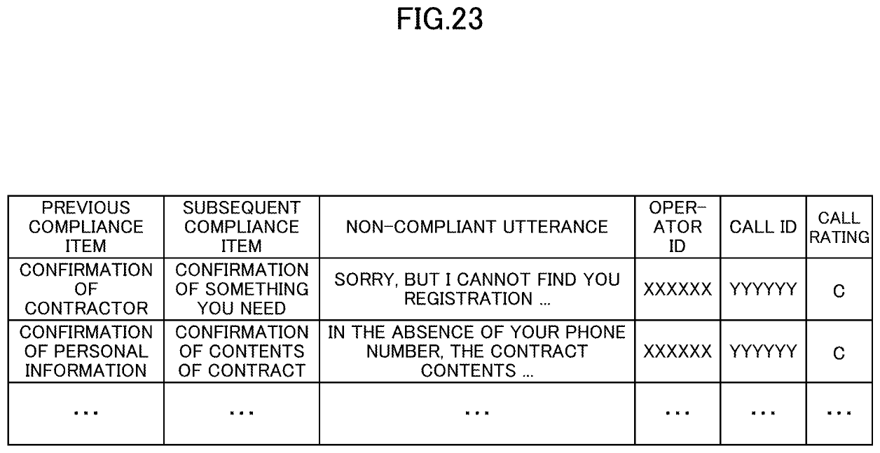

FIG. 23 illustrates an example of the visualized result of the utterance modification proposal. In the example as illustrated in FIG. 23, operator's utterance texts are visualized in “NON-COMPLIANT UTTERANCE”. This utterance text is an utterance that has a low call rating (“C” in the example as illustrated in FIG. 23) and dose not comply with the talk script. Therefore, the operator can consider whether or not his or her utterance is inappropriate (e.g., whether or not an unnecessary utterance not included in the talk script is made) in consideration of this utterance text. Also, for example, the supervisor can confirm whether or not something unexpected happened to the operator from this utterance text, and also can provide the operator with education, guidance, and the like.

In the example as illustrated in FIG. 22, when the call rating is “A”, the call rating is regarded as high. However, for example, when the call rating “A” or “B”, the call rating may also be regarded as high. That is, the value at which the call rating is determined to be high may have multiple values or a certain range. In this case, the visualized result of the script addition proposal may enable re-arrangement, narrowing-down, and the like of the utterance texts in accordance with the call rating. Similarly, the value at which the call rating is determined to be low may have multiple values or a certain range. In this case, the visualized result of the utterance modification proposal may enable re-arrangement, narrowing-down, and the like of the utterance texts in accordance with the call rating.

Step S305: The compliance rate visualizing part 221 generates the visualized information of the compliance rate, one of the rating scores, in step S302, and transmits the generated visualized information to the operator terminal 20 or the supervisor terminal 30. Thereby, the compliance rate is visualized on the display of the operator terminal 20 or the supervisor terminal 30.

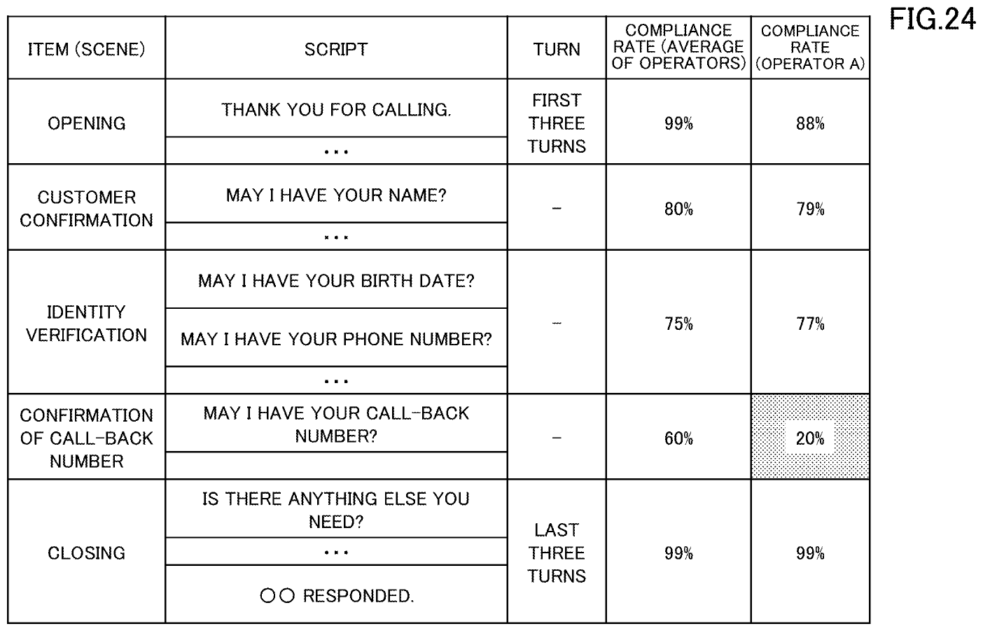

FIG. 24 illustrates an example of the visualized result of the compliance rate of a certain operator (hereinafter this operator is referred to as “Operator A”). In the example as illustrated in FIG. 24, an average compliance rate of the operators and the compliance rate of Operator A are visualized for each item (scene) of the talk script. Also, at this time, the cell in which the compliance rate of Operator A is especially low (e.g., the cell in which the compliance rate is equal to or lower than a certain threshold) is displayed in a manner that is different from the others cells. In the example as illustrated in FIG. 24, the compliance rate “20%” of Operator A in the item “CONFIRMATION OF CALL-BACK NUMBER” is visualized in a noticeable manner. Thereby, Operator A or the supervisor can know the item (scene) in which the compliance rate is especially low.

In this manner, in the example as illustrated in FIG. 24, the compliance rate of a general operator and the compliance rate of a specific operator can be compared with each other. Thus, for example, the specific operator can confirm the item that he or she cannot comply with well, among other items. When the compliance rate of the specific operator is low, if the average compliance rate of the operators is also low, it can be found that the item of interest is an item with which any operator does not readily comply.

In the example as illustrated in FIG. 24, the average compliance rate of operators and the compliance rate of a certain operator are visualized for each item of the talk script. However, this is merely illustrative, and the compliance rate may be visualized in accordance with various other criteria.

For example, for each talk script, the compliance rate in a call in which the call rating is “A” and the compliance rate in a call in which the call rating is “C” may be visualized. At this time, for example, an item in which the compliance rate is low in the call in which the call rating is “A”, an item in which the compliance rate is high in the call in which the call rating is “C”, and the like may be visualized in a noticeable manner. The item in which the call rating is high but the compliance rate is low is likely to have an unnecessary script in the script of that item, and modification of the script can be considered. Similarly, the item in which the call rating is low but the compliance rate is high is likely to have an unnecessary script, and modification of the script can be considered. Whether the compliance rate is high or low may be determined through comparison with a threshold. However, for example, it may be determined in accordance with whether or not there exists a significant difference by performing a test or the like.

Step S306: The compliance rate visualizing part 221 generates visualized information of an operator's utterance, and transmits the generated visualized information to the operator terminal 20 or the supervisor terminal 30. Thereby, the operator's utterance is visualized on the display of the operator terminal 20 or the supervisor terminal 30. For example, when the operator or the supervisor selects a desired item in the visualized result of the compliance rate, the operator or the supervisor can visualize a list of utterance texts (operator's utterances) complying with that item.

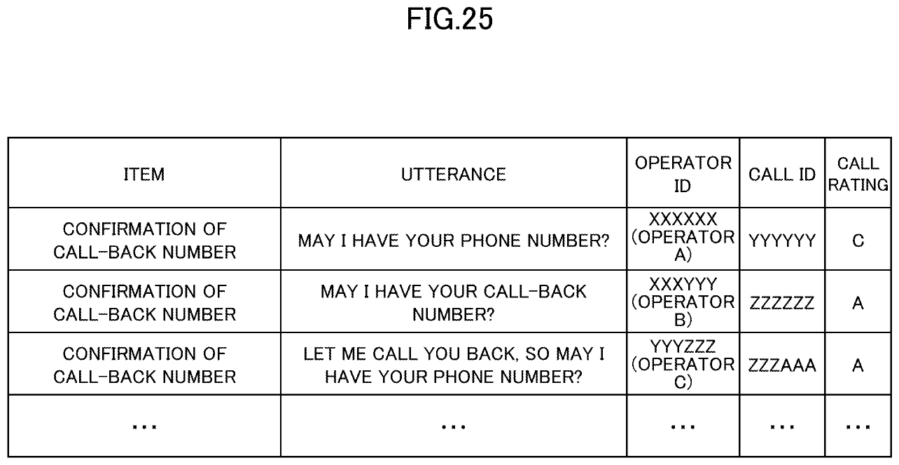

FIG. 25 illustrates an example of a list of operator's utterances when the item “CONFIRMATION OF CALL-BACK NUMBER” in the visualized result of the compliance rate as illustrated in FIG. 24. In FIG. 25, the utterance texts in the item “CONFIRMATION OF CALL-BACK NUMBER” are visualized. However, for example, the utterance texts in all of the items may be displayed, and then, in response to selecting the item “CONFIRMATION OF CALL-BACK NUMBER” in the visualized result of the compliance rate as illustrated in FIG. 24, narrowing-down of the utterance texts may be performed to visualize the utterance texts in FIG. 25.

In the example as illustrated in FIG. 25, the utterance texts of Operator A, Operator B, and Operator C in the item “CONFIRMATION OF CALL-BACK NUMBER” are visualized. The call ID in which the utterance text of interest was uttered, and the call rating of the call of interest are also visualized. Thereby, the operator or the supervisor can know the utterances of various operators in the item of interest and the call ratings at that time. This operators' utterance list may enable re-arrangement, narrowing-down, and the like of the utterance texts in accordance with the call rating. The example as illustrated in FIG. 25 does not visualize scripts, but may visualize scripts.

Step S307: The compliance rate visualizing part 221 generates visualized information of the relevant information, and transmits the generated visualized information to the operator terminal 20 or the supervisor terminal 30. Thereby, the relevant information is visualized on the display of the operator terminal 20 or the supervisor terminal 30. For example, the operator or the supervisor can visualize the relevant information by performing an operation for displaying the relevant information in the visualized result of the compliance rate. Thereby, for example, it is possible to know a reason why the operator was not able to comply with the script. Thus, the relevant information can be utilized for modification of the script, the FAQ, and the like.

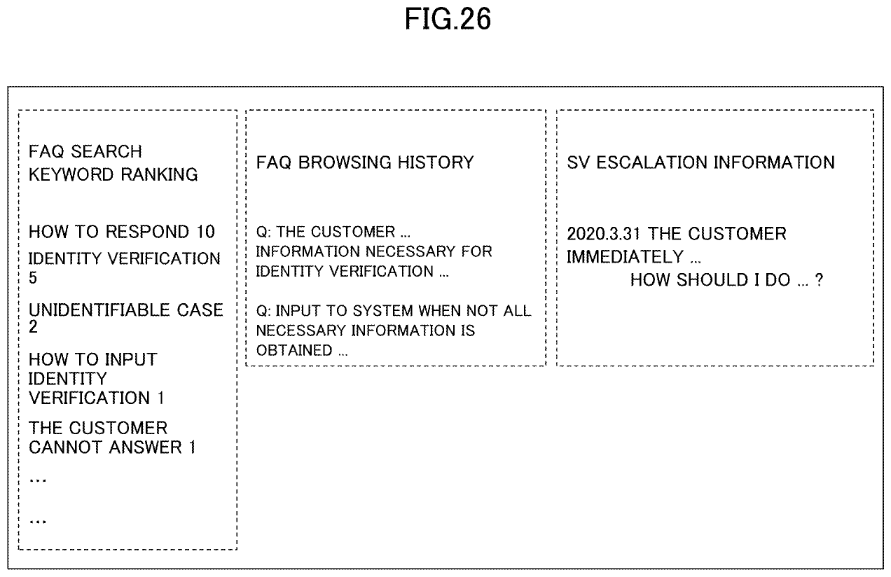

FIG. 26 illustrates an example of the visualized result of the relevant information. The example as illustrated in FIG. 26 visualizes “FAQ SEARCH KEYWORD RANKING”, “FAQ BROWSING HISTORY”, and “SV ESCALATION INFORMATION” are visualized as examples of the relevant information of a certain operator. The above relevant information may not be relevant information of a certain operator, but may be, for example, aggregated relevant information of multiple operators.

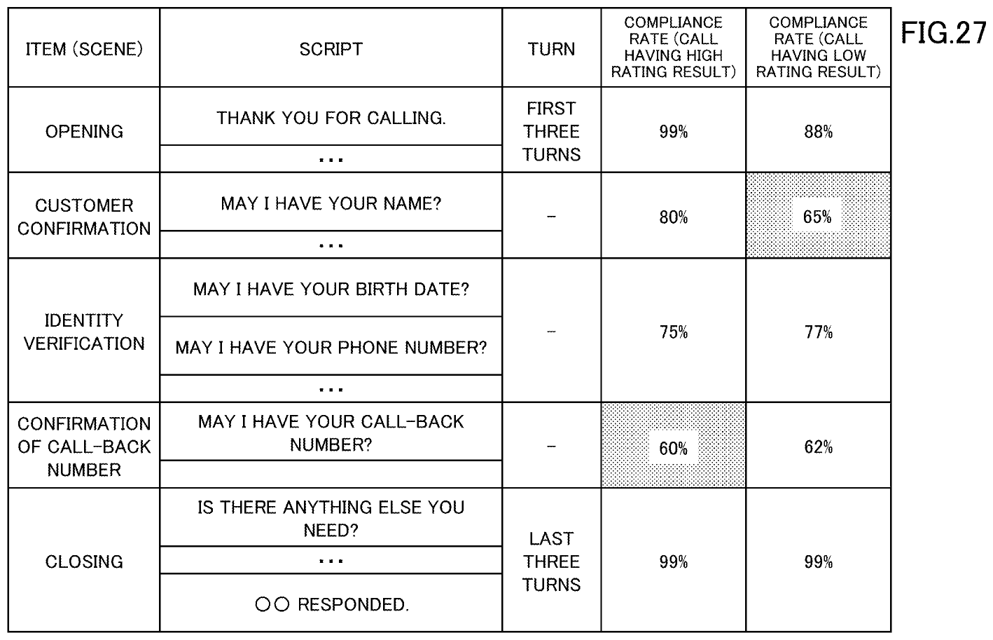

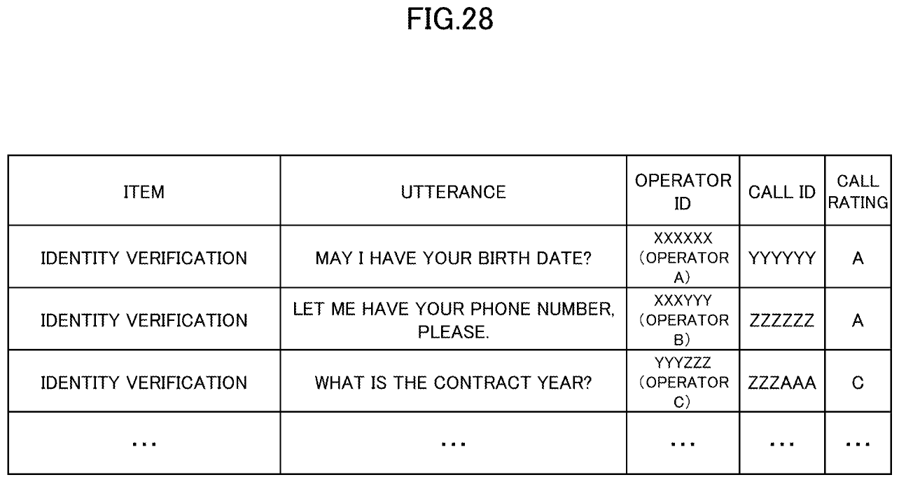

Although the compliance rate of the operator is visualized in step S306, the compliance rate of the talk script may be visualized. For example, the visualized result of the compliance rate as illustrated in FIG. 27 may be visualized. The example as illustrated in FIG. 27 visualizes, for each item of the talk script, the compliance rate of a call in which the rating result is high (e.g., a call in which the call rating is equal to or higher than a predetermined threshold) and the compliance rate of a call in which the rating result is low (e.g., a call in which the call rating is lower than a predetermined threshold). At this time, when the operator or the supervisor selects a desired item in the visualized result of the compliance rate as illustrated in FIG. 27, a list of the utterance texts (operator's utterances) complying with the item of interest can be visualized. For example, the example as illustrated in FIG. 28 is the visualized result when the item “IDENTITY VERIFICATION” is selected in the visualized result of the compliance rate as illustrated in FIG. 27 (i.e., when the cell in the 4^{th} row and the 1^{st} column is selected in the visualized result as illustrated in FIG. 27). Because the visualized result as illustrated in FIG. 28 is similar to that as illustrated in FIG. 25, detailed description thereof will be omitted.

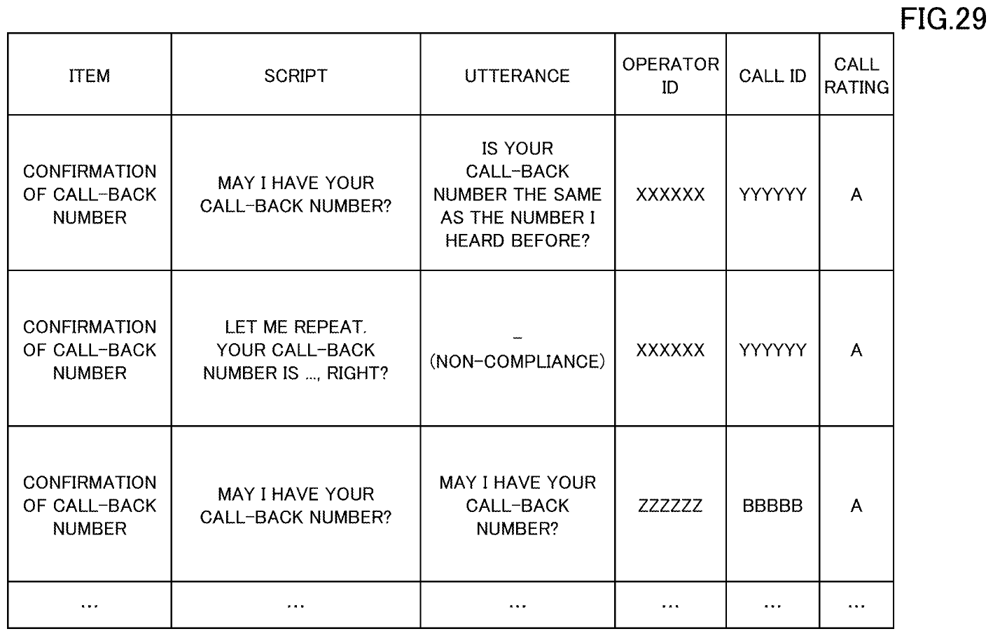

In the above, the operator or the supervisor selects the cell in the 1^{st} column that expresses the item in the visualized result as illustrated in FIG. 27. However, a desired cell other than the cells in the 1^{st} column may be selected in the visualized result as illustrated in FIG. 27. The example as illustrated in FIG. 29 is the visualized result when the cell in the 5^{th} row and the 4^{th} column is selected in the visualized result as illustrated in FIG. 27 (i.e., when the cell of the compliance rate (call having a high rating result) in the item “CONFIRMATION OF CALL-BACK NUMBER” is selected). The visualized result as illustrated in FIG. 29 displays the item “CONFIRMATION OF CALL-BACK NUMBER” and narrows down the operator's utterances having high rating results.

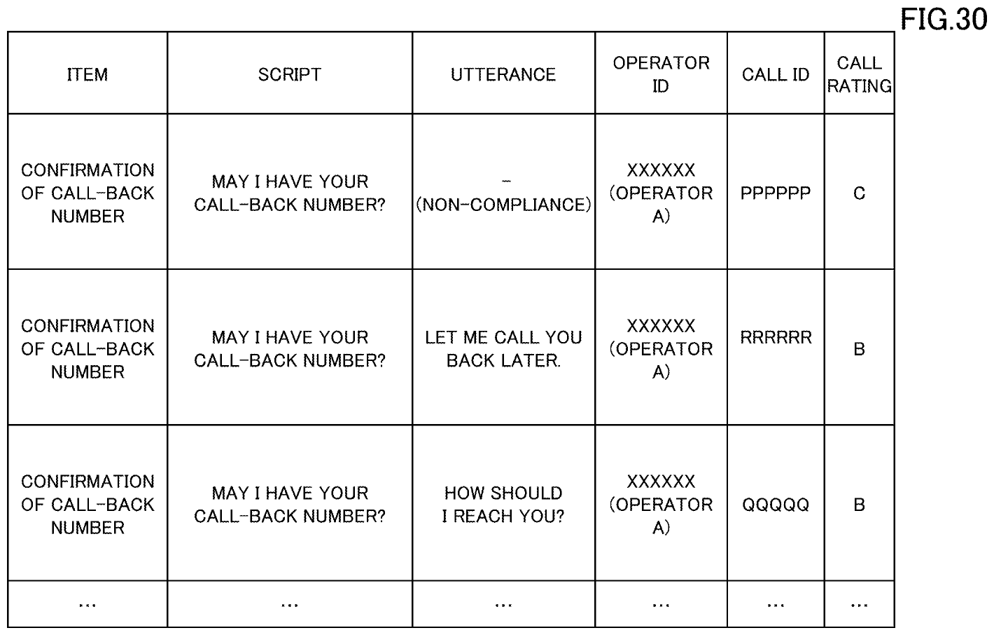

As another example, FIG. 30 illustrates the visualized result when the cell in the 5^{th} row and the 5^{th} column is selected in the visualized result as illustrated in FIG. 24 (i.e., when the cell of the compliance rate (Operator A) in the item “CONFIRMATION OF CALL-BACK NUMBER” is selected). The visualized result as illustrated in FIG. 30 displays the item “CONFIRMATION OF CALL-BACK NUMBER” and narrows down the operator's utterances of Operator A.

In this manner, when a desired cell is selected in the visualized results as illustrated in FIG. 24 and FIG. 27, operator utterances corresponding to this cell (and the corresponding items, operator ID, call ID, call rating, and the like) are displayed as a list.

The present invention is not limited to the above embodiments that are specifically disclosed. Various modifications, changes, combinations with publicly known techniques, and the like are possible without departing from the scope of claims recited.

With respect to the above embodiments, the following clauses are further disclosed.

### Clause 1

A visualized information generation apparatus, including:
a memory; and
at least one processor connected to the memory, in which
the processor is configured to
   generate visualized information in response to an input of information indicating compliance, non-compliance, or both between an utterance content expressed by an utterance text and an utterance content expressed by a predetermined script,
   the visualized information being for visualizing a range estimated to be in compliance in a manner that is different from a manner in which a range estimated to be in non-compliance is visualized,
   the range estimated to be in compliance being a range of the utterance content expressed by one of the utterance text or the script in which the utterance content expressed by one of the utterance text or the script is estimated to comply with the utterance content expressed by another of the utterance text or the script, and
   the range estimated to be in non-compliance being a range of the utterance content expressed by one of the utterance text or the script in which the utterance content expressed by one of the utterance text or the script is estimated not to comply with the utterance content expressed by another of the utterance text or the script.

### Clause 2

The visualized information generation apparatus as described in clause 1, in which
the utterance text is previously divided into one or more divided utterance texts, and the script is previously divided into one or more divided scripts, and
the information indicating the compliance, the non-compliance, or both is information indicating compliance, non-compliance, or both between the divided utterance texts and the divided scripts.

### Clause 3

The visualized information generation apparatus as described in clause 2, in which
the processor is configured to
   calculate a degree of compliance between the utterance content expressed by the divided utterance texts and the utterance content expressed by the divided scripts, as a score, based on the information indicating the compliance, the non-compliance, or both, and
   generate visualized information for visualizing the score for each of the divided scripts of a same script that is the script.

### Clause 4

The visualized information generation apparatus as described in clause 3, in which
the score includes
   a precision rate that expresses a degree in which the divided utterance texts estimated to be in compliance are included in all of the divided utterance texts, or
   a recall rate that expresses a degree in which the divided scripts estimated to be in compliance are included in all of the divided scripts.

### Clause 5

The visualized information generation apparatus as described in any one of clauses 2 to 4, in which
the processor is configured to
   generate visualized information for items of a same script that is the script or for same divided scripts that are the divided scripts,
   the visualized information being for visualizing, as a list,
      the items, and
      the divided utterance texts of utterance contents estimated to comply with utterance contents expressing the divided scripts corresponding to the items.

### Clause 6

The visualized information generation apparatus as described in any one of clauses 2 to 4, in which
the processor is configured to
   generate visualized information for visualizing, as a list,
      utterance contents of the divided utterance texts estimated not to comply with utterance contents expressed by the divided scripts.

### Clause 7

The visualized information generation apparatus as described in clause 6, in which
the processor is configured to
   generate the visualized information for visualizing, as the list,
      the utterance contents of the divided utterance texts estimated not to comply with the utterance contents expressed by the divided scripts, by a unit of an utterance subject that utters the utterance text.

### Clause 8

The visualized information generation apparatus as described in clause 6 or 7, in which
the processor is configured to
   generate visualized information for visualizing items before and after the item corresponding to the divided script or divided utterance texts before and after the divided utterance text, upon generating the visualized information for visualizing, as the list,
      the utterance contents of the divided utterance texts estimated not to comply with the utterance contents expressed by the divided scripts.

### Clause 9

The visualized information generation apparatus as described in any one of clauses 2 to 8, in which
the processor is configured to
   obtain rating information on the utterance text from exterior, and
   generate visualized information for visualizing, as a list, the obtained rating information in association with the divided utterance texts, and in association with the information indicating the compliance, the non-compliance, or both between the divided utterance texts and the divided scripts.

### Clause 10

The visualized information generation apparatus as described in any one of clauses 2 to 9, in which
the processor is configured to
   obtain relevant information to the utterance text from exterior, and
   generate visualized information for visualizing, as a list,
      the obtained relevant information in association with the divided utterance texts, and
   the relevant information includes
      a search keyword of FAQ used upon being uttered by an utterance subject that utters the utterance text,
      a browsing history of FAQ used upon being uttered by the utterance subject that utters the utterance text,
      history information indicating an inquiry to others upon being uttered by the utterance subject that utters the utterance text, or
      any combination of the search keyword, the browsing history, and the history information.

### Clause 11

The visualized information generation apparatus as described in clause 1, in which
the processor includes
   an identifying part configured to identify a modification proposal for the utterance text or the script, based on rating information on the utterance text obtained from exterior and based on the information indicating the compliance, the non-compliance, or both.

### Clause 12

The visualized information generation apparatus as described in clause 3, in which
the processor is configured to
   identify a modification proposal for the utterance text or the script, based on the information indicating the compliance, the non-compliance, or both and based on the score.

### Clause 13

The visualized information generation apparatus as described in clause 11, in which
the processor is configured to
   of the utterance content expressed by the utterance text in which the rating information is equal to or higher than a predetermined rating, identify an utterance content of the range estimated not to comply with the utterance content expressed by the script, as the modification proposal expressing an utterance content to be added to the script,
   of the utterance content expressed by the utterance text in which the rating information is lower than the predetermined rating, identify an utterance content of the range estimated to comply with the utterance content expressed by the script, as the modification proposal expressing an utterance content to be deleted from the script, and
   of the utterance content expressed by the utterance text in which the rating information is lower than the predetermined rating, identify an utterance content of the range estimated not to comply with the utterance content expressed by the script, as the modification proposal expressing an utterance content that is unnecessary in the utterance text.

### Clause 14

The visualized information generation apparatus as described in any one of clauses 11 to 13, in which
the processor is configured to
   generate visualized information for visualizing the modification proposal.

### Clause 15

A non-transitory recording medium storing a computer-executable program so as to execute a visualized information generation process, the visualized information generation process including:
generating visualized information in response to an input of information indicating compliance, non-compliance, or both between an utterance content expressed by an utterance text and an utterance content expressed by a predetermined script,
   the visualized information being for visualizing a range estimated to be in compliance in a manner that is different from a manner in which a range estimated to be in non-compliance is visualized,
   the range estimated to be in compliance being a range of the utterance content expressed by one of the utterance text or the script in which the utterance content expressed by one of the utterance text or the script is estimated to comply with the utterance content expressed by another of the utterance text or the script, and
   the range estimated to be in non-compliance being a range of the utterance content expressed by one of the utterance text or the script in which the utterance content expressed by one of the utterance text or the script is estimated not to comply with the utterance content expressed by another of the utterance text or the script.

### REFERENCES

Reference 1: Katsuki Chousa, Masaaki Nagata, Masaaki Nishino. Bilingual Text Extraction as Reading Comprehension, arXiv: 2004.14517v1.
Reference 2: Jacob Devlin, Ming-Wei Chang, Kenton Lee, Kristina Toutanova. BERT: Pre-training of Deep Bidirectional Transformers for Language Understanding, arXiv: 1810.04805v2.
Reference 3: Masaaki Nagata, Chousa Katsuki, Masaaki Nishino. A Supervised Word Alignment Method based on Cross-Language Span Prediction using Multilingual BERT, arXiv: 2004.14516v1.

### REFERENCE SIGNS LIST

1 Contact center system
10 Estimation apparatus
20 Operator terminal
30 Supervisor terminal
40 PBX
50 Customer terminal
60 Communication network
101 Input device
102 Display device
103 External I/F
103a Recording medium
104 Communication I/F
105 Processor
106 Memory device
107 Bus
201 Voice recognition part
202 Compliance estimation processing part
203 Storage part
211 Dividing part
212 Matching part
213 Correspondence information generating part
214 Compliance estimating part
215 Compliance range visualizing part
216 Aggregating part
217 Compliance state visualizing part
218 Rating part
219 Modification proposal identifying part
220 Modification proposal visualizing part
221 Compliance rate visualizing part

1. A visualized information generation apparatus, comprising:
a memory; and
at least one processor connected to the memory, wherein
the processor is configured to
generate visualized information in response to an input of information indicating compliance, non-compliance, or both between an utterance content expressed by an utterance text and an utterance content expressed by a predetermined script,
the visualized information being for visualizing a range estimated to be in compliance in a manner that is different from a manner in which a range estimated to be in non-compliance is visualized,
the range estimated to be in compliance being a range of the utterance content expressed by one of the utterance text or the script in which the utterance content expressed by one of the utterance text or the script is estimated to comply with the utterance content expressed by another of the utterance text or the script, and
the range estimated to be in non-compliance being a range of the utterance content expressed by one of the utterance text or the script in which the utterance content expressed by one of the utterance text or the script is estimated not to comply with the utterance content expressed by another of the utterance text or the script.

2. The visualized information generation apparatus according to claim 1, wherein
the utterance text is previously divided into one or more divided utterance texts, and the script is previously divided into one or more divided scripts, and
the information indicating the compliance, the non-compliance, or both is information indicating compliance, non-compliance, or both between the divided utterance texts and the divided scripts.

3. The visualized information generation apparatus according to claim 2, wherein
the processor is configured to
calculate a degree of compliance between the utterance content expressed by the divided utterance texts and the utterance content expressed by the divided scripts, as a score, based on the information indicating the compliance, the non-compliance, or both, and
generate visualized information for visualizing the score for each of the divided scripts of a same script that is the script.

4. The visualized information generation apparatus according to claim 3, wherein
the score includes
a precision rate that expresses a degree in which the divided utterance texts estimated to be in compliance are included in all of the divided utterance texts, or
a recall rate that expresses a degree in which the divided scripts estimated to be in compliance are included in all of the divided scripts.

5. The visualized information generation apparatus according to claim 2, wherein
the processor is configured to
generate visualized information for items of a same script that is the script or for same divided scripts that are the divided scripts,
the visualized information being for visualizing, as a list,
the items, and
the divided utterance texts of utterance contents estimated to comply with utterance contents expressing the divided scripts corresponding to the items.

6. The visualized information generation apparatus according to claim 2, wherein
the processor is configured to
generate visualized information for visualizing, as a list, utterance contents of the divided utterance texts estimated not to comply with utterance contents expressed by the divided scripts.

7. The visualized information generation apparatus according to claim 6, wherein
the processor is configured to
generate the visualized information for visualizing, as the list,
the utterance contents of the divided utterance texts estimated not to comply with the utterance contents expressed by the divided scripts, by a unit of an utterance subject that utters the utterance text.

8. The visualized information generation apparatus according to claim 6, wherein
the processor is configured to
generate visualized information for visualizing items before and after the item corresponding to the divided script or divided utterance texts before and after the divided utterance text, upon generating the visualized information for visualizing, as the list,
the utterance contents of the divided utterance texts estimated not to comply with the utterance contents expressed by the divided scripts.

9. The visualized information generation apparatus according to claim 2, wherein
the processor is configured to
obtain rating information on the utterance text from exterior, and
generate visualized information for visualizing, as a list,
the obtained rating information in association with the divided utterance texts, and in association with the information indicating the compliance, the non-compliance, or both between the divided utterance texts and the divided scripts.

10. The visualized information generation apparatus according to claim 2, wherein
the processor is configured to
obtain relevant information to the utterance text from exterior, and
generate visualized information for visualizing, as a list, the obtained relevant information in association with the divided utterance texts, and
the relevant information includes
a search keyword of FAQ used upon being uttered by an utterance subject that utters the utterance text,
a browsing history of FAQ used upon being uttered by the utterance subject that utters the utterance text,
history information indicating an inquiry to others upon being uttered by the utterance subject that utters the utterance text, or
any combination of the search keyword, the browsing history, and the history information.

11. The visualized information generation apparatus according to claim 1, wherein
the processor is configured to
identify a modification proposal for the utterance text or the script, based on rating information on the utterance text obtained from exterior and based on the information indicating the compliance, the non-compliance, or both.

12. The visualized information generation apparatus according to claim 3, wherein
the processor is configured to
identify a modification proposal for the utterance text or the script, based on the information indicating the compliance, the non-compliance, or both and based on the score.

13. The visualized information generation apparatus according to claim 11, wherein
the processor is configured to
of the utterance content expressed by the utterance text in which the rating information is equal to or higher than a predetermined rating, identify an utterance content of the range estimated not to comply with the utterance content expressed by the script, as the modification proposal expressing an utterance content to be added to the script,
of the utterance content expressed by the utterance text in which the rating information is lower than the predetermined rating, identify an utterance content of the range estimated to comply with the utterance content expressed by the script, as the modification proposal expressing an utterance content to be deleted from the script, and
of the utterance content expressed by the utterance text in which the rating information is lower than the predetermined rating, identify an utterance content of the range estimated not to comply with the utterance content expressed by the script, as the modification proposal expressing an utterance content that is unnecessary in the utterance text.

14. The visualized information generation apparatus according to claim 11, wherein
the processor is configured to
generate visualized information for visualizing the modification proposal.

15. A visualized information generation method, comprising:
generating visualized information in response to an input of information indicating compliance, non-compliance, or both between an utterance content expressed by an utterance text and an utterance content expressed by a predetermined script,
the generation being executed by a computer,
the visualized information being for visualizing a range estimated to be in compliance in a manner that is different from a manner in which a range estimated to be in non-compliance is visualized,
the range estimated to be in compliance being a range of the utterance content expressed by one of the utterance text or the script in which the utterance content expressed by one of the utterance text or the script is estimated to comply with the utterance content expressed by another of the utterance text or the script, and
the range estimated to be in non-compliance being a range of the utterance content expressed by one of the utterance text or the script in which the utterance content expressed by one of the utterance text or the script is estimated not to comply with the utterance content expressed by another of the utterance text or the script.

16. A non-transitory recording medium storing a computer-executable program so as to execute a visualized information generation process, the visualized information generation process including:
generating visualized information in response to an input of information indicating compliance, non-compliance, or both between an utterance content expressed by an utterance text and an utterance content expressed by a predetermined script,
the visualized information being for visualizing a range estimated to be in compliance in a manner that is different from a manner in which a range estimated to be in non-compliance is visualized,
the range estimated to be in compliance being a range of the utterance content expressed by one of the utterance text or the script in which the utterance content expressed by one of the utterance text or the script is estimated to comply with the utterance content expressed by another of the utterance text or the script and
the range estimated to be in non-compliance being a range of the utterance content expressed by one of the utterance text or the script in which the utterance content expressed by one of the utterance text or the script is estimated not to comply with the utterance content expressed by another of the utterance text or the script.
